(19) United States
(12) Patent Application Publication
(10) Pub. No.: US 2026/0077999 A1
(43) Pub. Date: Mar. 19, 2026

(54) Semi-Continuous Process for Co-Production of CO2-Free Hydrogen and High Value Carbon via Hydrocarbon Pyrolysis

(71) Applicants: The Board of Trustees of the Leland Stanford Junior University, Stanford, CA (US); Susteon, Inc., Cary, NC (US)

(72) Inventors: Arunava Majumdar, Menlo Park, CA (US); Dohyung Kim, Philadelphia, PA (US); Shang Zhai, Columbus, OH (US); Edward Sun, Cincinnati, OH (US); Matteo Cargnello, Menlo Park, CA (US); Raghubir P. Gupta, Stanford, CA (US); Vasudev Haribal, Stanford, CA (US); Andrew Tong, Stanford, CA (US); Marco Gigantino, Palo Alto, CA (US)

(73) Assignees: The Board of Trustees of the Leland Stanford Junior University, Stanford, CA (US); Susteon, Inc., Cary, NC (US)

(21) Appl. No.: 19/149,469

(22) PCT Filed: Jan. 22, 2024
(86) PCT No.: PCT/US24/12455

§ 371 Date: Jul. 18, 2025

Related U.S. Application Data
(60) Provisional application No. 63/480,875, filed on Jan. 20, 2023.

(51) Int. Cl. C01B 3/30; B01J 6/00; B01J 8/26; B01J 21/04; B01J 23/745; B01J 35/45; C01B 3/26

(52) U.S. Cl. CPC C01B 3/28; B01J 6/008; B01J 8/26; B01J 21/04; B01J 23/745; B01J 35/45; C01B 3/26; B01J 2208/00548; B01J 2235/15; B01J 2235/30; C01B 2203/1058; C01B 2203/1076

(57) ABSTRACT

Systems and methods for a semi-continuous, hydrocarbon pyrolysis process to simultaneously produce CO₂-free H₂ and high value carbon, wherein the value of the produced carbon offsets the cost of H₂ production, are described. The methods comprise a process, wherein steps of: hydrocarbon pyrolysis over a metal-based catalyst to produce H2 and high value carbon; in-situ dislodging of the high value carbon from the catalyst with a vigorous gas stream fluidization; and the catalyst reductive regeneration are semi-continuously cycled such as to continuously recycle the catalyst.

### CROSS-REFERENCE TO RELATED APPLICATIONS

The present application claims priority under 35 U.S.C. 119(e) to U.S. Provisional Application No. 63/480,875, filed on Jan. 20, 2023, the disclosure of which is incorporated herein by reference in its entirety.

### STATEMENT REGARDING FEDERALLY SPONSORED RESEARCH

This invention was made with Government support under Grant No. DE-AR0001192—SPO 159211 awarded by the Advanced Research Projects Agency-Energy (ARPA-E), U.S. Department of Energy. The Government has certain rights in this invention.

### FIELD OF THE INVENTION

The invention is generally directed to systems and methods for a semi-continuous co-production of hydrogen and high value carbon from hydrocarbon pyrolysis free of direct carbon dioxide emissions.

### BACKGROUND OF THE INVENTION

Hydrogen that is free of greenhouse gas (GHG) emissions is a key vector to fuel a net-zero emissions economy. Today, 70 million tons per year of hydrogen (H₂) are produced globally, largely for ammonia and fertilizer production via the Haber-Bosch process, and for hydrogenation reactions in the refining industry (see, for example: IEA. The Future of Hydrogen. https://www.iea.org/reports/the-future-of-hydrogen (2019), the disclosure of which is incorporated herein by reference). Roughly 95% of today's annual production of H₂ is sourced from fossil fuels, mostly by steam methane reforming (SMR), followed by the water-gas shift (WGS) reaction, or coal gasification (as discussed, for example, in: IRENA. Hydrogen from renewable power: Technology outlook for the energy transition. (2018); and Fan, Z., et al. Catalytic decomposition of methane to produce hydrogen: A review. J Energy Chem. 58, 415-430 (2021), the disclosures of which are incorporated herein by reference). SMR produces hydrogen at an affordable cost of $1.2-1.5 per kilogram of hydrogen (kg-H₂) at a natural gas price of ˜$3 per million British thermal units (mmBTU), however, this process also produces approximately 10 kg of carbon dioxide (a GHG) per kg of hydrogen, wherein capturing and sequestering this carbon dioxide increases the hydrogen cost to $1.5-1.8/kg-H₂.

Furthermore, water electrolysis, which is the only viable technology that can produce CO₂-free H₂ today, produces H₂ at costs 3-4 times higher than the current cost of SMR (˜$4/kg-H₂). As such, these high costs are currently infeasible for meeting the H₂ demands at today's production scales (see, for example: Nikolaidis, P. & Poullikkas, A. A comparative overview of hydrogen production processes. Renew. Sustain. Energy Rev. 67, 597-611 (2017), the disclosure of which is incorporated herein by reference). Consequently, in order to reach the cost of $1/kg-H₂, the cost of the installed electrolyzers needs to be reduced by a factor of 3 to 4, while maintaining a continuously GHG-free electricity grid, with a cost of 1.5 cents per kilowatt-hour (#/kWh) or lower. It should be noted here, that the best water-splitting electrocatalysts operate at ˜50 kWh/kg-H₂, which is 80% of the theoretical water electrolysis thermodynamic limit of ˜40 kWh/kg-H₂. Therefore, an electricity price of 2 $/kWh with a 100% capacity factor leads to an energy cost alone of water splitting to be $1/kg-H₂. However, GHG-free electricity at 1.5 #/kWh with a 100% capacity factor will lead to an energy cost of ˜$0.75/kg-H₂, leaving room of $0.25/kg-H₂ for the levelized capital cost of installed electrolyzers. Accordingly, while water electrolysis certainly has potential for applications in small-to-medium H₂ production scales, especially in the regions of the world where natural gas is not abundant, options for other more scalable technologies must also be explored. Thus, there exists a great need for GHG-free, efficient, yet affordable methods of H₂ production.

### SUMMARY OF THE INVENTION

Various embodiments are directed to a method for a semi-continuous hydrocarbon pyrolysis including:
providing a reactor, wherein the reactor is a fluidized-bed reactor including a catalyst bed;
providing a hydrocarbon at a hydrocarbon flow rate;
providing a pyrolysis catalyst, such that the pyrolysis catalyst facilitates a conversion of the hydrocarbon to hydrogen and a high value carbon, and loading the pyrolysis catalyst into the catalyst bed;
providing a dislodging agent at a dislodging flow rate;
providing a reducing agent at a reducing flow rate;
   wherein the hydrocarbon flow rate, the dislodging flow rate, and the reducing flow rate are gas flow rates at least sufficient to fluidize the pyrolysis catalyst within the catalyst bed; and
      repeating a plurality of cycles, each cycle at least including steps:
reacting the hydrocarbon to produce hydrogen and the high value carbon by flowing the hydrocarbon at the hydrocarbon flow rate over the pyrolysis catalyst within the reactor at a pyrolysis temperature for a pyrolysis duration; and collecting the hydrogen;
dislodging the high value carbon from the pyrolysis catalyst by flowing the dislodging agent at the dislodging flow rate over the pyrolysis catalyst within the reactor at a dislodging temperature for a dislodging duration; and collecting thus dislodged high value carbon and any additional hydrogen; and
regenerating the pyrolysis catalyst by flowing the reducing agent at the reducing flow rate over the pyrolysis catalyst within the reactor at a reducing temperature for a reducing duration;
   to continuously generate and collect CO₂-free H₂ and the high value carbon over a course of the plurality of cycles in situ.

In various such embodiments, providing the pyrolysis catalyst and loading the pyrolysis catalyst into the catalyst bed includes first providing a pyrolysis pre-catalyst, wherein the pyrolysis pre-catalyst is inactive or less active than the pyrolysis catalyst; loading the pyrolysis pre-catalyst into the reactor, and activating the pyrolysis pre-catalyst by flowing the reducing agent at the reducing flow rate over the pyrolysis pre-catalyst within the reactor at the reducing temperature for the reducing duration to obtain the pyrolysis catalyst in the catalyst bed.

In still various such embodiments, the hydrocarbon is a gas selected from the group consisting of: an alkane CₙH₂ₙ₊₂, wherein n is 1 to 4; an alkene CₙH₂ₙ, wherein n is 2 to 4; an alkyne CₙH₂ₙ₋₂, wherein n is 2 to 4; and any of isomer and combination thereof.

In still yet various embodiments, the hydrocarbon is methane.

In yet still various such embodiments, the hydrocarbon further includes less than 10% by volume of a hydrocarbon promoter selected from the group consisting of: hydrogen, steam, a sulfur-containing compound, including thiophene, carbon monoxide, another hydrocarbon, and any combination thereof.

In yet various such embodiments, the hydrocarbon flow rate is a gas hourly space velocity between 100 h⁻¹ and 10,000 h⁻¹ at the standard temperature of 0° C. and the standard pressure of 1 atm.

In various such embodiments, the hydrocarbon flow rate is a gas hourly space velocity between 1,000 h⁻¹ and 10,000 h−1 at the standard temperature of 0° C. and the standard pressure of 1 atm.

In still various such embodiments, the pyrolysis catalyst includes a catalytic metal and a plurality of support particles.

In yet still various such embodiments, wherein the pyrolysis catalyst includes the catalytic metal and the plurality of support particles, the pyrolysis catalyst includes less than 50% of the catalytic metal by weight.

In still yet various such embodiments, wherein the pyrolysis catalyst includes the catalytic metal and the plurality of support particles, the pyrolysis catalyst includes less than 10% of the catalytic metal by weight.

In yet various such embodiments, wherein the pyrolysis catalyst includes the catalytic metal and the plurality of support particles, the catalytic metal is an element selected from the group consisting of: iron, copper, molybdenum, nickel, cobalt, and any combination thereof.

In various such embodiments, wherein the pyrolysis catalyst includes the catalytic metal and the plurality of support particles, the plurality of support particles possesses a surface area of between 20 to 300 m²/g, as measured using Brunauer-Emmett-Teller method.

In still various such embodiments, wherein the pyrolysis catalyst includes the catalytic metal and the plurality of support particles, the plurality of support particles are Geldart class A, B, or D particles with diameters ranging from 30 μm to 2000 μm.

In yet still various such embodiments, wherein the pyrolysis catalyst includes the catalytic metal and the plurality of support particles, the plurality of support particles are high surface area particles selected from the group consisting of: alumina, including θ-Al₂O₃ and γ-Al₂O₃, silica, magnesium oxide, zirconia, and any combination thereof.

In still yet various such embodiments, the pyrolysis catalyst is Fe/θ-Al₂O₃.

In yet various such embodiments, wherein providing the pyrolysis catalyst and loading the pyrolysis catalyst into the catalyst bed includes first providing the pyrolysis pre-catalyst, the pyrolysis pre-catalyst is Fe₂O₃/θ-Al₂O₃ and the pyrolysis catalyst is Fe/θ-Al₂O₃.

In various such embodiments, the pyrolysis catalyst is FeNP/θ-Al₂O₃.

In still various such embodiments, the conversion of the hydrocarbon is 20 to 100%.

In yet still various such embodiments, the conversion of the hydrocarbon is 40 to 100%.

In still yet various such embodiments, the conversion of the hydrocarbon is 60 to 100%.

In yet various such embodiments, the high value carbon is fibrous and or fibrous crystalline carbon.

In various such embodiments, the high value carbon is a valuable carbonaceous matter selected from the group consisting of: SWCNTs and DWCNTs, wherein the SWCNTs and the DWCNTs are in the range of 1-5 nm diameter; MWCNTs, wherein the MWCNTs are in the range of 2-50 nm diameter; and carbon fibers with tube diameters larger than 50 nm, but still possessing an aspect ratio of length to diameter of greater than 25; and any combination thereof.

In still various such embodiments, the dislodging agent includes an inert gas and an optional dislodging promoter, and wherein the optional dislodging promoter is less than 20% by volume of the dislodging agent.

In yet still various such embodiments, wherein the dislodging agent includes an inert gas and an optional dislodging promoter, the optional dislodging promoter is less than 5% by volume of the dislodging agent.

In still yet various such embodiments, wherein the dislodging agent includes an inert gas and an optional dislodging promoter, the inert gas includes a gas selected from the group consisting of: argon, nitrogen, helium, and any combination thereof.

In yet various such embodiments, wherein the dislodging agent includes an inert gas and an optional dislodging promoter, the optional dislodging promoter includes a gas selected from the group consisting of: hydrogen, steam, carbon monoxide, oxygen, and any combination thereof.

In various such embodiments, the dislodging agent includes argon and steam, and wherein steam is less than 3.1% by volume of the dislodging agent.

In still various such embodiments, wherein the dislodging agent includes argon and steam, steam is 2.5% by volume of the dislodging agent.

In yet still various such embodiments, the dislodging flow rate is a superficial gas velocity 3 to 100 times of the minimum fluidization velocity of the pyrolysis catalyst.

In still yet various such embodiments, the reducing agent is a gas selected from the group consisting of: hydrogen, carbon monoxide, hydrocarbons, ammonia, and any combination thereof.

In yet various such embodiments, the reducing agent is hydrogen gas.

In various such embodiments, the pyrolysis temperature is between 500° C. and 1000° C.

In still various such embodiments, the pyrolysis temperature is between 500° C. and 900° C.

In yet still various such embodiments, the pyrolysis temperature is 850° C.

In still yet various such embodiments, the dislodging temperature is between 400° C. and 1000° C.

In yet various such embodiments, the dislodging temperature is between 500° C. and 900° C.

In various such embodiments, the dislodging temperature is above 700° C.

In still various such embodiments, the dislodging temperature is 850° C.

In yet still such embodiments, the pyrolysis temperature, the dislodging temperature, and the reducing temperature are the same temperature.

In yet various such embodiments, the hydrocarbon is methane, the pyrolysis catalyst is Fe/θ-Al₂O₃, including 4.8 wt. % of Fe, the dislodging agent is humidified argon at 2.5% by volume of steam, the reducing agent is H₂, and the pyrolysis, the dislodging, and the reducing temperatures are 850° C.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which form a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIG. 1 provides graphics showing the model-predicted effect of the carbon price on the H₂ production cost for a 10 ton-per-day H₂ production scale assuming 25% CH₄ conversion (left), and 90% CH₄ conversion (right); wherein the graphics are based on the assumptions of 1) $3 per MMBTU of natural gas, 2) 3 V/kWh electricity cost, and 3) a conservative capital cost estimate of $1,525 per kg/day of H₂ capacity, in accordance with embodiments of the application.

FIG. 2 provides a chart comparison of to date reports on the co-synthesis of carbon nanotubes (CNTs) and H₂ by CH₄ pyrolysis according to prior art.

FIG. 3A schematically illustrates the systems and methods for hydrocarbon pyrolysis to co-produce CO₂-free H₂ and high value carbon; while FIG. 3B schematically illustrates the reactor employed in the methods in accordance with embodiments of the application.

FIG. 4 provides plots illustrating the course of CH₄ pyrolysis over 2-hour conducted over either 5 wt. % Fe/Al₂O₃ (top line), or 1 wt. % of Fe/Al₂O₃ (middle line), or bare Al₂O₃ carrier particles (bottom line), in accordance with embodiments of the application.

FIGS. 5A through 5D illustrate various stages of the Fe/θ-Al₂O₃ pyrolysis catalyst synthesis in which the as-synthesized state is Fe₂O₃/θ-Al₂O₃, wherein FIGS. 5A and 5B provide a scanning electron microscopy (SEM) image and a Brunauer-Emmett-Teller (BET) surface area analysis, respectively, of bare 275 μm diameter θ-Al₂O₃ beads prior to their impregnation with Fe;

FIG. 5C provides a SEM image of the as-synthesized Fe₂O₃/Al₂O₃ pyrolysis catalyst particles; and FIG. 5D provides X-ray diffraction (left) and X-ray fluorescence (right) characterizations of the as-synthesized Fe/θ-Al₂O₃ pyrolysis catalyst particles in which the as-synthesized state is Fe₂O₃/θ-Al₂O₃, in accordance with embodiments of the application.

FIG. 6 illustrates and compares the surface area characteristics of the Al₂O₃ carrier particles of different phase by presenting the SEM images (top row) and the corresponding BET surface area analyses (bottom row) for α-Al₂O₃, γ-Al₂O₃, and θ—Al₂O₃, wherein it is shown that γ- and θ-Al₂O₃ have similar morphology and surface area, while α-Al₂O₃ has a substantially lower surface area and different morphology, according to prior art.

FIG. 7 illustrates and compares the effect that the phase of Al₂O₃ carrier particles has on the CNT-growing performance of the CH₄ pyrolysis that uses them, by providing CH₄ conversion data (top left), Raman spectroscopy data (top right), and SEM images of the post pyrolysis Fe/Al₂O₃ beads (bottom); wherein it is shown that the CNT growth on Fe/α-Al₂O₃ after 20 minutes is substantially worse than on Fe/γ-Al₂O₃ and on Fe/θ-Al₂O₃, in accordance with embodiments of the application.

FIG. 8 illustrates synthesis and characterization of Fe nanoparticle catalyst particles (FeNP)/θ-Al₂O₃ for hydrocarbon pyrolysis, as well as characterization of their CNT-growing capabilities, by providing: a transmission electron microscopy (TEM) image (top row, left) of and size distribution data (top row, right) for as-synthesized FeNPs with 3.5 nm average diameter; as well as Raman spectrum (average of 5 scans) (bottom row, left) and SEM image (bottom row, right) of CNTs grown over FeNPs drop-casted on the 275 μm Fe/θ-Al₂O₃ beads by CH₄ pyrolysis; wherein the G/D ratio for the produced CNTs is 2.8 (which is higher than the 1.7 G/D ratio observed for CNTs produced with the wet-impregnated Fe/θ-Al₂O₃, in accordance with embodiments of the application.

FIG. 9 schematically illustrates a fluidized-bed reactor set-up for the hydrocarbon pyrolysis, in accordance with embodiments of the application.

FIG. 10 provides a SEM image of the Fe/O-Al₂O₃ pyrolysis catalyst after the 1′ cycle of CH₄ pyrolysis, showing that the catalyst particles are covered by the pyrolysis step produced CNTs, in accordance with embodiments of the application.

FIG. 11 shows CNT dislodging by high flow rate of 2.5% H₂O/Ar used as the dislodging agent, as observed downstream of the reactor, in accordance with embodiments of the application.

FIG. 12 provides Gas Chromatography (GC) data illustrating CH₄ conversion during cycling experiments with CNT dislodging by 3080 sccm of 2.5% H₂O/Ar, as well as the same data for control experiments wherein neat Ar and 20% O₂/Ar was used for CNT dislodging, in accordance with embodiments of the application.

FIG. 13 shows changes in CH₄ outlet gas mole fraction, H₂ outlet gas mole fraction, and CH₄ conversion resulting from 10 cycles of CH₄ pyrolysis with CNT dislodging by 2.5% H₂O/Ar, as measured using mass spectroscopy, wherein mass spectroscopy offers higher time resolution compared to gas chromatography, albeit with less accuracy, in accordance with embodiments of the application.

FIG. 14 tabulates mole fraction of the product gases exiting the reactor during cyclic CH₄ pyrolysis, as measured by gas chromatography, in accordance with embodiments of the application.

FIG. 15A shows cumulative H₂ yield from 10 cycles of CH₄ pyrolysis and CNT dislodging by 2.5% H₂O/Ar, while FIG. 15B shows cycle averaged (i.e., time-averaged within each cycle) H₂ evolution rate from 10 cycles of CH₄ pyrolysis and CNT dislodging by 2.5% H₂O/Ar, in accordance with embodiments of the application.

FIG. 16 provides a table showing mole fraction of the product gases exiting the reactor during CNT dislodging by 2.5% H₂O/Ar as measured by gas chromatography, wherein the H₂ and CO concentrations were constant throughout CNT dislodging, in accordance with embodiments of the application.

FIG. 17 provides a table accounting for carbon balance of 10 cycle experiment of CH₄ pyrolysis with CNT dislodging by 2.5% H₂O/Ar, in accordance with embodiments of the application.

FIG. 18 shows cumulative yield of dislodged CNT by cycle with CNT dislodging by high flow rate 2.5% H₂O/Ar, as well as the same for control experiments with Ar and 20% O₂/Ar CNT dislodging, wherein “*” denotes total solid yield as opposed to dislodged carbon yield due to insufficient sample amount for XRF analysis, in accordance with embodiments of the application.

FIGS. 19A and 19B illustrate the characterization of carbon dislodged over 10 cycles of the CH₄ pyrolysis and carbon dislodging by 2.5% H₂O/Ar purge experiments, wherein FIG. 19A provides TEM images of cumulatively dislodged CNT after 1 (left) and 10 (middle) cycles, along with a SEM image of CNTs dislodged after 1 cycle (right); while FIG. 19B shows Raman spectroscopy of cumulatively dislodged CNTs by cycle (top), wherein the G/D ratio of each dislodged carbon sample is the average and standard deviation of five individual measurements, and thermogravimetric (TG)/differential thermogravimetric (DTG) analysis (middle and bottom, respectively) of cumulatively dislodged CNT (by cycle number) oxidized in CO₂ at a 5° C./min temperature ramp rate, wherein the main mass drop peak at 900° C. indicates that the cumulative dislodged CNT is mostly crystalline, in accordance with embodiments of the application.

FIG. 20A provides SEM images and FIG. 20B provides TEM images of carbon dislodged by high flow rate 2.5% H₂O/Ar after 1, 3, 6, and 10 cycles, in accordance with embodiments of the application.

FIG. 21 illustrates SEM imaging tracking of the state of the Fe/θ-Al₂O₃ pyrolysis catalyst throughout 10 cycles of CH₄ pyrolysis cycling with CNT dislodging by high flow rate 2.5% H₂O/Ar, wherein arrows indicate the section of the sample where the higher magnification image was taken for the cases where particle surface was not spatially uniform, in accordance with embodiments of the application.

FIG. 22 shows Raman spectroscopy characterization of the carbon found on the particles of the Fe/θ-Al₂O₃ pyrolysis catalyst by cycle after the CH₄ pyrolysis step (left) and after the CNT dislodging step (right), wherein the G/D ratio of each dislodged carbon sample is the average and standard deviation of 5 individual measurements, in accordance with embodiments of the application.

FIG. 23 provides a schematic diagram of the hypothesized mechanism for preferential dislodging of crystalline carbon in accordance with embodiments of the application.

FIG. 24 provides data collected for TG analysis of CO₂ oxidation of Fe/θ-Al₂O₃ beads having deposited (i.e., non-dislodged) carbon after the CNT dislodging step of cycles 1, 3, 6, and 10 of the CH₄ pyrolysis/dislodging cycling experiments, in accordance with embodiments of the application.

FIG. 25 illustrates the systems and methods for the hydrocarbon pyrolysis to co-produce CO₂-free H₂ and high value carbon in the context of possible applications for the products thereof in accordance with embodiments of the application.

### DETAILED DISCLOSURE

Turning now to the schemes, data, and images, embodiments of systems and methods for a semi-continuous process wherein pyrolysis of a hydrocarbon affords H₂ and high value carbon are described. In many embodiments, the methods comprise cycles of repeated steps of hydrocarbon pyrolysis over a catalyst designed to produce H₂ and high-value carbon, followed by in-situ (within the reactor) dislodging of the high value carbon with a vigorous gas stream fluidization, and in-situ catalyst regeneration with a reducing agent purge. In many embodiments, the high value carbon comprises fibrous carbon and/or fibrous crystalline carbon. In many embodiments, the high value carbon comprises carbon nanotubes (CNTs) and or carbon fibers (CFs). In many embodiments, the systems comprise a fluidized-bed reactor equipped with a pyrolysis catalyst. In many embodiments, the pyrolysis catalyst comprises a catalytic metal supported by carrier particles. In many such embodiments, the catalytic metal is iron (Fe), wherein Fe is further supported by fluidized support/carrier particles. In many such embodiments, the carrier particles are porous θ-Al₂O₃, such that the pyrolysis catalyst is Fe/θ-Al₂O₃. In many embodiments, the pyrolysis catalyst is continuously reused and recycled without interruption. In many embodiments, the dislodging of the high value carbon is achieved by vigorous gas purging with a dislodging agent. In many embodiments, the dislodging agent comprises humidified argon. In many embodiments, the pyrolysis catalyst is regenerated with a reducing agent purge following the dislodging of the high value carbon and prior to the hydrocarbon pyrolysis step of the next cycle. In many embodiments, the reducing agent is H₂. In many embodiments, the sale of high value carbon produced with the instant systems and according to the instant methods offsets the price of the carbon dioxide-free hydrogen production.

Decarbonization of the energy, transportation, and industrial sectors would be greatly aided by affordable CO₂-free H₂. Unfortunately, nearly all of today's hydrogen is produced from fossil fuels, mostly by steam methane reforming (SMR)—a process accompanied by greenhouse gas (GHG) emissions. Water electrolysis can be used to produce CO₂-free H₂, however such methods remain prohibitively expensive. On the other hand, pyrolysis is a technology that can produce CO₂-free hydrogen along with solid carbon and requires much less energy per mole of hydrogen than water electrolysis. However, past attempts at pyrolysis have suffered from the production of low-quality carbon and/or failure to re-use the catalyst for multiple cycles—both important factors for lowering the cost of hydrogen and scaling up such processes.

More specifically, the pyrolysis of hydrocarbons to produce GHG-free H₂ and solid carbon proceeds via the reaction:

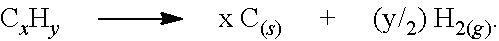

For this reaction, the minimum energy requirement at standard states is considerably less per mole of H₂ (<40 kJ/mol H₂) than 286 kJ per mole of H₂ (˜40 kWh/kg-H₂) obtained from water electrolysis (H₂O→H₂+½ O₂). Therefore, such significant difference in minimum energy requirements suggests that pyrolysis, if efficiently designed, will consume less energy to produce H₂ than water electrolysis, resulting in a lower cost of H₂ production. Specifically, this process can potentially be economically favorable at medium-to-large CO₂-free H₂ production scales, slotting in between water electrolysis (less than 1-ton H₂/day) and SMR with carbon capture (greater than 100-tons H₂/day). In addition, hydrocarbon transport infrastructure already exists in many areas, allowing for easy supply of the feedstock directly at the sites where H₂ is consumed, thus avoiding the problems often associated with safe, large volume, yet low cost transport of H₂.

To this end, pyrolysis of methane to CO₂-free H₂ in conjunction with high value carbon nanomaterials, such as, for example, carbon nanotubes (CNTs), presents itself as the hydrocarbon pyrolysis process with the greatest potential, due to methane's high H:C ratio (4:1), natural abundance, and affordability in regions possessing natural gas, and also ease of management within a reactor:

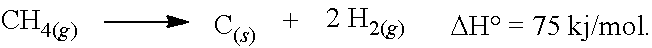

Furthermore, CH₄ pyrolysis for H₂ production and, separately, CNT synthesis have been extensively studied and reported (see, for example: Chen, L., et al. Catalytic Hydrogen Production from Methane: A Review on Recent Progress and Prospect. Catalysts 10, 858 (2020); Qian, J. X. et al. Methane decomposition to produce CO-free hydrogen and nano-carbon over metal catalysts: A review. Int. J. Hydrog. Energy 45, 7981-8001 (2020); Ashik, U. P. M., et al. Production of greenhouse gas free hydrogen by thermocatalytic decomposition of methane—A review. Renew. Sustain. Energy Rev. 44, 221-256 (2015); Alves, L., et al. Catalytic methane decomposition to boost the energy transition: Scientific and technological advancements. Renew. Sustain. Energy Rev. 137, 110465 (2021); Fan, Z., et al. Catalytic decomposition of methane to produce hydrogen: A review. J Energy Chem. 58, 415-430 (2021), the disclosures of which are incorporated herein by reference). Notably, the concept of using CH₄ pyrolysis to produce carbon black and other pyrolysis products, such as acetylene, has been around for a century, starting in the 1920s (Wang, M.-J., et al. Carbon Black. in Kirk-Othmer Encyclopedia of Chemical Technology (John Wiley & Sons, Ltd, 2003) doi:https://doi.org/10.1002/0471238961.0301180204011414.a01.pub2, the disclosure of which is incorporated herein by reference). As such, many approaches to this process have since then been attempted, including heterogeneous and floating catalysis, plasma, and molten metal processes. More recently, a scale-up of methane pyrolysis was completed using high-temperature plasma to produce carbon black and hydrogen, wherein the produced hydrogen was the process's byproduct to carbon black, which, in turn, is sold for about $0.50/kg ($500/ton), primarily for use in tire production (see, for example, The Monolith Process. https://monolith-corp.com/methane-pyrolysis (2022), the disclosure of which is incorporated herein by reference). In general, methane pyrolysis for CO₂-free H₂ production has received intense attention due to its enormous potential, despite the remaining technical challenges, which include: catalyst stability and process longevity, methane activation (i.e., high energy requirement), low H₂ yields, and carbon growth control (as discussed in, for example: Technology| Decarbonizing Natural Gas. C-Zero https://www.czero.energy/technology; and BASF. Innovative Processes for Climate-Smart Chemistry. BASF Report 2021, the disclosures of which are incorporated herein by reference).

As such, significant fundamental research efforts towards pyrolysis catalysts have also been ongoing, especially as related to reducing catalyst deactivation. More specifically, heterogeneous catalysis-based CH₄ pyrolysis methods for H₂ generation are typically conducted over metal catalysts, such as Fe, Ni and Co, and suffer from catalyst deactivation by carbon deposition. Alternatively, carbon-based pyrolysis catalysts, such as carbon nanotubes (CNTs), activated carbon, and metal carbides, are less prone to deactivation than metal catalysts, however, they generally require higher reaction temperatures. Moreover, Upham et al. in Upham, D. C. et al. Catalytic molten metals for the direct conversion of methane to hydrogen and separable carbon. Science 358, 917-921 (2017), the disclosure of which is incorporated herein by reference, and others (e.g., in: Geiβler, T. et al. Hydrogen production via methane pyrolysis in a liquid metal bubble column reactor with a packed bed. Chem. Eng. J. 299, 192-200 (2016); and Steinberg, M. Fossil fuel decarbonization technology for mitigating global warming. Int. J. Hydrog. Energy 24, 771-777 (1999), the disclosures of which are incorporated herein by reference) have proposed molten metal reactor systems for methane pyrolysis to allow for easy post-reaction separation of the catalyst from the produced carbon via buoyancy, yet the carbon produced via such methods is not crystalline and is contaminated with metals, while the overall process requires high temperatures and large H₂ production scales to be economically viable (as discussed, for example, in: Parkinson, B., et al. Techno-Economic Analysis of Methane Pyrolysis in Molten Metals: Decarbonizing Natural Gas. Chem. Eng. Technol. 40, 1022-1030 (2017); and Parkinson, B. et al. Hydrogen production using methane: Techno-economics of decarbonizing fuels and chemicals. Int. J Hydrog. Energy 43, 2540-2555 (2018), the disclosures of which are incorporated herein by reference).

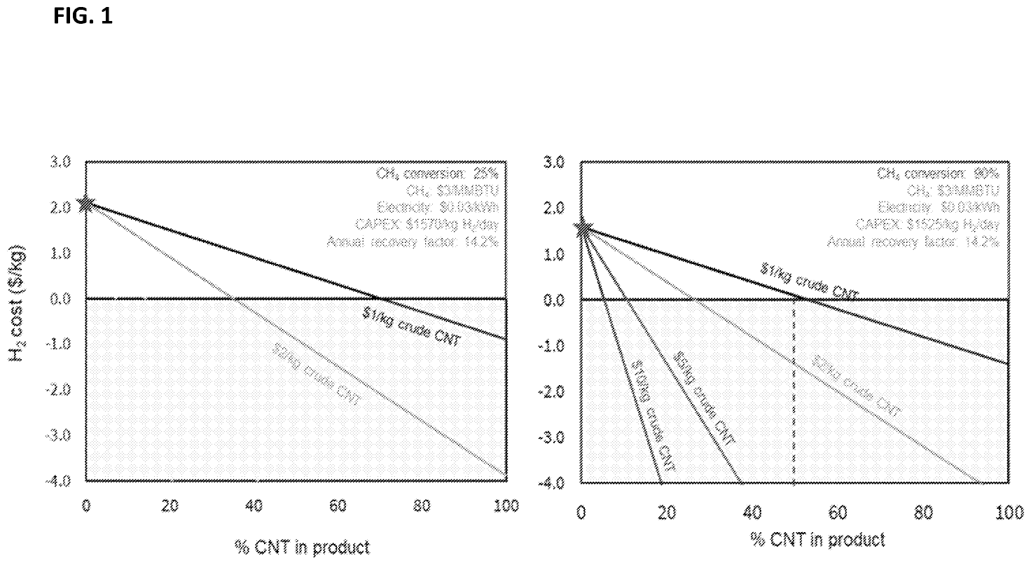

Furthermore, while the CO₂-free H₂ produced from CH₄ pyrolysis would be a drop-in replacement for H₂ from SMR and WGS, the produced solid carbon (in a 3:1 mass ratio to the H₂) becomes critical once the carbon production scale crosses ˜15 million tons (MT)/yr (the total market size for non-combustible solid carbon), as discussed, for example, in Pasquali, M. & Mesters, C. We can use carbon to decarbonize—and get hydrogen for free. Proc. Natl. Acad. Sci. 118, e2112089118 (2021), the disclosure of which is incorporated herein by reference. More specifically, synthesis of inexpensive yet sufficiently performing carbon nanotubes or carbon fibers (CFs) can provide a route to scale. Currently, CNTs and CFs are reserved for high-end applications in industries such as aerospace, electronics, or medicine, due to their high cost. However, large production volumes of high-value crystalline CNTs and CFs could lower these costs, so that CNT- and CF-based structural materials could replace and displace necessary but highly emission-intensive structural materials like steel, aluminum, and cement. Accordingly, the higher value of such crystalline carbon (>$5/kg-C) can offset the cost of H₂ production, such as to lower it to the prices where H₂ can be economically used for residential, commercial, and industrial heating (˜$0.50/kg H₂) (see, for example: Majumdar, A., et al. A framework for a hydrogen economy. Joule 5, 1905-1908 (2021); and Henry, A., et al. Five thermal energy grand challenges for decarbonization. Nat. Energy 5, 635-637 (2020), the disclosures of which are incorporated herein by reference). For example, FIG. 1 presents a techno-economic model-predicted effect of the carbon price on the hydrogen production cost, emphasizing the potential of a continuous CH₄ pyrolysis process.

To this end, CNT synthesis from CH₄ was first demonstrated by Peigney et al. in Carbon nanotubes grown in situ by a novel catalytic method. J Mater. Res. 12, 613-615 (1997), the disclosure of which is incorporated herein by reference, and Kong et al. in Synthesis of individual single-walled carbon nanotubes on patterned silicon wafers. Nature 395, 878-881 (1998), the disclosure of which is incorporated herein by reference. Since then, many catalyst/support combinations that successfully grew CNTs or CFs from CH₄ have been reported. In general, the CNT production from CH₄ pyrolysis can be divided into two classes: 1) pyrolysis on unsupported catalysts, wherein small metal catalyst particles (<10 nm) on which CNTs grow are produced within the reactor; and 2) pyrolysis on supported catalysts, wherein the metal active sites are created on fluidized or fixed substrates. However, previous work has mostly focused on optimizing CNT quality (e.g., number of walls and degree of crystallinity), without much regard for the produced H₂. In addition, when CNTs are prioritized, the catalyst is typically destroyed to separate it from the produced carbon, leading to lower hydrogen production rates as a result. Nevertheless, a pyrolysis process conducted over a catalyst supported by floating or fluidized substrate allows for simpler reactor design and operation and, as such, for scaling of the process to the magnitudes relevant to meaningful H₂ production. Accordingly, a desirable, scalable CH₄ pyrolysis process for GHG-free H₂ production needs to rely on a supported catalyst system, wherein both the catalyst and the process itself need to be optimized for all of: high hydrocarbon conversion to H₂, high quality CNTs production, CNT recovery that is gentle towards the catalyst, and catalyst regeneration.

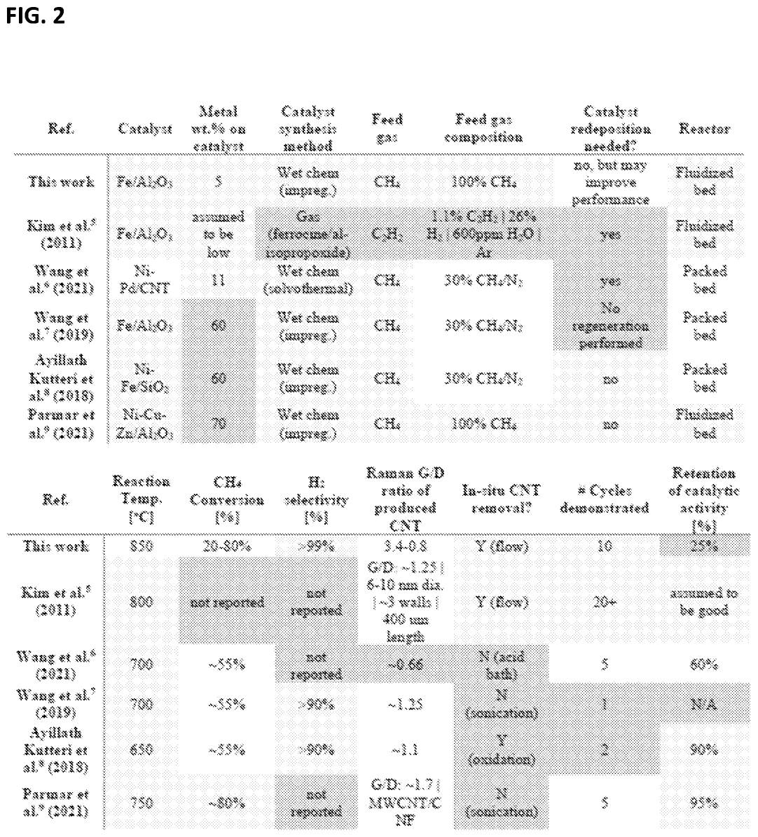

Still, the catalyst regeneration studies reported to date have been mostly limited to use of combustion or gasification to remove the pyrolysis produced carbon, wherein such removal methods result in the production of CO₂, and do not allow for the recovery and collection of the produced carbon. As such, only a few studies have considered H₂ generation, CNT production, and CNT collection together as a continuous system (see, for example: Wang, I.-W., et al. Methane Pyrolysis for Carbon Nanotubes and COₓ-Free H₂ over Transition-Metal Catalysts. Energy Fuels 33, 197-205 (2019); Ayillath Kutteri, D., et al. Methane decomposition to tip and base grown carbon nanotubes and COₓ-free H₂ over mono- and bimetallic 3 d transition metal catalysts. Catal. Sci. Technol. 8, 858-869 (2018); Parmar, K. R., et al. Blue hydrogen and carbon nanotube production via direct catalytic decomposition of methane in fluidized bed reactor: Capture and extraction of carbon in the form of CNTs. Energy Convers. Manag. 232, 113893 (2021); and Wang, I.-W. et al. Catalytic decomposition of methane into hydrogen and high-value carbons: combined experimental and DFT computational study. Catal. Sci. Technol. 11, 4911-4921 (2021), the disclosures of which are incorporated herein by reference). For example, Kim et al. in Sub-millimeter-long carbon nanotubes repeatedly grown on and separated from ceramic beads in a single fluidized bed reactor. Carbon 49, 1972-1979 (2011), the disclosure of which is incorporated herein by reference, demonstrated a semi-continuous system for CNT growth, wherein the resulting CNTs were subsequently dislodged and collected, and wherein the catalyst was treated in preparation for another round of CNT growth. However, this system used C₂H₂ as the carbon feedstock, and its H₂ yield remained unknown (but presumed low). Here, it should be noted that, in general, acetylene is not a very appealing choice of the starting material for a large scale generation of H₂, because any such process would require additional safety considerations due to C₂H₂'s extremely unstable and flammable nature, and, as such, would be very expensive due to high costs of safe C₂H₂ handing and transportation, in addition to high cost of acetylene itself. Moreover, FIG. 2 provides a comparison chart of similar previous work, all of which have significant weaknesses in view of the considerations for the efficient production of GHG-free and high value carbon. As such, there exists a need for a continuous or semi-continuous supported-catalyst system and method that would simultaneously produce high quality, high value carbon and H₂ in high yields from hydrocarbon pyrolysis, especially CH₄ pyrolysis due to its abundance and low cost, and that would also allow for an efficient collection of the produced high value carbon, and also possess good process longevity.

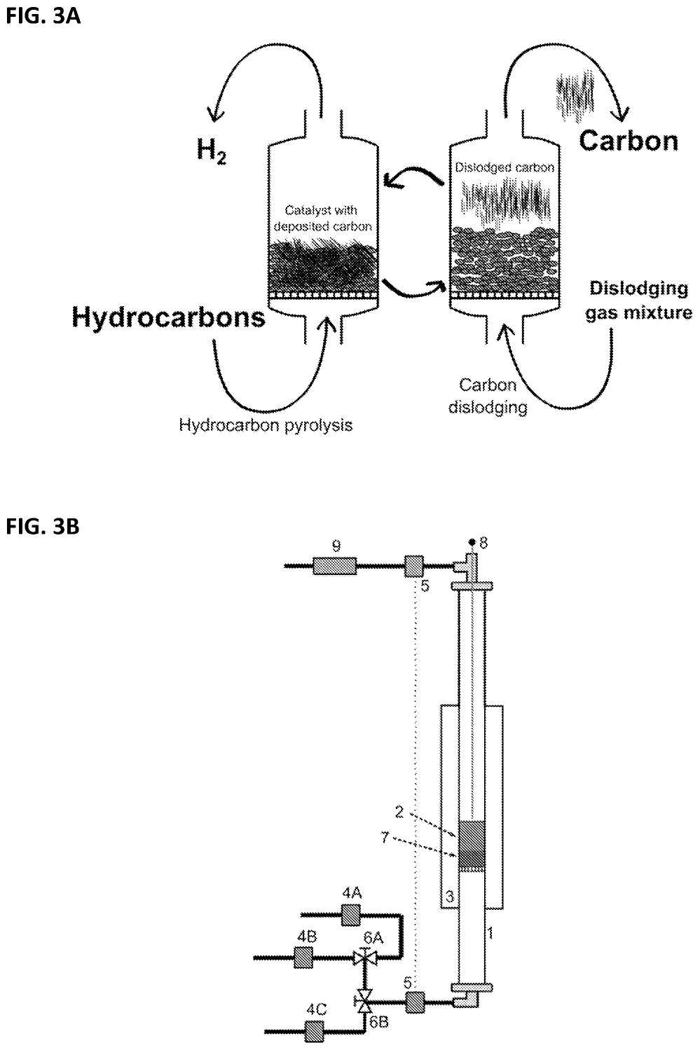

Accordingly, this application is directed to embodiments of systems and methods for a semi-continuous pyrolysis of a hydrocarbon to co-produce CO₂-free H₂ and a high-value carbon, as schematically illustrated in FIG. 3A. In many embodiments, the systems at least comprise a reactor, a carbon collection device, and a pyrolysis catalyst designed to produce H₂ in high yield and high value, fibrous carbon. In many embodiments, the reactor is a fluidized-bed reactor. In some embodiments, the reactor is a fluidized-bed reactor as schematically depicted in FIG. 3B, wherein the reactor at least comprises the following components. a reactor tube 1, such that it can withstand pyrolysis temperatures; a catalyst bed 2; a heating source (e.g., heater) 3; one or more flow controllers, such as, for example, 4A, 4B, 4C, or more, as needed; a differential pressure transducer 5; one or more flow valves, such as, for example, 6A and 6B; inert material as heat and gas distributor 7; a temperature sensor (e.g., a thermocouple) 8; a particulate filter for carbon collection 9. In many such embodiments, the reaction tube comprises a material selected from the group consisting of: quartz, stainless steel, high-temperature nickel-alloyed steel, steel that allows for use of a ceramic refractory liner, and any combination thereof. In many embodiments, the carbon collection device is a solids filter (e.g. baghouse) and/or a gas-solid separation device (e.g. cyclone) positioned downstream of the reactor.

In many embodiments, the methods comprise continuously or semi-continuously cycled steps comprising:
1) high value carbon growth via pyrolysis of the hydrocarbon over the pyrolysis catalyst at a pyrolysis temperature for a pyrolysis duration;
2) in-situ (inside the reactor) dislodging of the high-value carbon via vigorous fluidization with a dislodging agent to recover the pyrolysis catalyst, followed by collection of the high value carbon downstream of the reactor; and
3) in-situ regeneration of the pyrolysis catalyst with a reducing agent purge.
   In many embodiments, the systems and methods of the instant application allow for at least 10 or more such cycles of semi-continuous growth and dislodging of the high value carbon with high hydrocarbon conversion and high selectivity towards H₂. In many embodiments, especially wherein the hydrocarbon is CH₄, the hydrocarbon conversion of the instant methods is 20-100%, affording correspondingly high H₂ yields. In many embodiments, the hydrocarbon conversion is 40-100%. In some embodiments, the hydrocarbon conversion is 60-100%. However, it should be noted here, that the extent of the hydrocarbon (e.g., CH₄) conversion is limited by thermodynamics of the instant methods, which in turn, depend on the temperature of the processes involved.

In many embodiments, the high value carbon comprises fibrous carbon. In many embodiments, the fibrous carbon is carbon nanotubes (CNTs). In many embodiments, the high value carbon is a valuable carbon comprising, more specifically, a carbon species/carbonaceous matter selected from the group: single-wall carbon nanotubes (SWCNTs) and double-wall carbon nanotubes (DWCNTs), wherein the SWCNTs and the DWCNTs are in the range of 1-5 nm diameter; multi-wall carbon nanotubes (MWCNTs), wherein the MWCNTs are in the range of 2-50 nm diameter; and carbon fibers with tube diameters larger than 50 nm, but still possessing an aspect ratio (length to diameter) of greater than 25; and any combination thereof. In many embodiments, the high value/valuable carbon specifically does not include carbon in the form of: amorphous carbon, carbon black, graphitic carbon in the form of sheets, and other non-fibrous forms of carbon. In some embodiments, the high-value carbon produced via the instant methods is a mixture of SWCNTs and MWCNTs, or any other combination of the valuable carbon species. In some embodiments, the high value carbon afforded by the instant systems and methods, such as, for example, the mixture of SWCNTs and MWCNTs, is subsequently fluid-processed into a CNT film.

In many embodiments, the hydrocarbon is methane. In many embodiments, the pyrolysis catalyst is Fe/θ-Al₂O₃. In many embodiments, the dislodging agent is gas. In many such embodiments, the dislodging agent is humidified argon. In many embodiments, the reducing agent is H₂. In many embodiments, the overall process is isothermal and conducted at 850° C. In some embodiments, the total yields of H₂ and the high value carbon after 10 process cycles of the instant methods employing the instant systems, with total of 512 mmol of methane pyrolyzed as the hydrocarbon, 251.7 mmol of water gasified during CNT dislodging, and approximately 14 g of Fe/θ-Al₂O₃ used as the pyrolysis catalyst, are at least 1,059 mmol H₂/g_{Fe} and 572 mg of CNTs, respectively, or higher.

In many embodiments, the process of the instant methods is semi-continuous, in that it can run continuously without requiring cool-down of the reactor between multiple cycles or removal of the catalyst from the reactor for catalyst regeneration between multiple cycles. In some embodiments, the semi-continuous process is operated in a continuous manner by flow switching between multiple reactors operating in parallel, wherein each reactor continuously cycles through the methods' steps of:
1) pyrolysis of the hydrocarbon to produce H₂ and the high value carbon;
2) purge with the dislodging agent to dislodge the high value carbon; and
3) reducing purge with H₂ to regenerate the catalyst.

In many such embodiments, the pyrolysis catalyst remains within its respective reactor at all times, while the reactor's gas supply is switched between different purging gases as needed to achieve the methods' steps described herein and comprising of: hydrocarbon pyrolysis, high value carbon dislodging, and catalyst regenerative reduction.

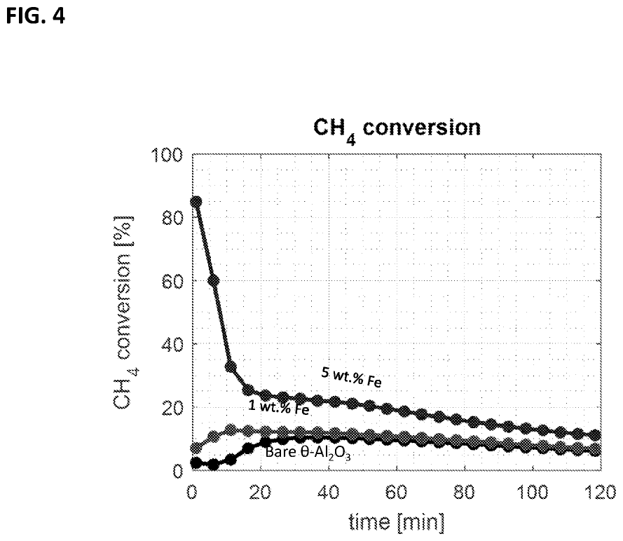

In many embodiments, the hydrocarbon pyrolysis step to co-produce H₂ and the high value carbon comprises a chemical reaction of a gaseous flow of the hydrocarbon (pure or a mixture comprising several hydrocarbons) and co-fed gases over the pyrolysis catalyst within the reactor at the pyrolysis temperature for the pyrolysis duration. As a result of this chemical reaction, H₂ is produced along with the high value carbon, such as, for example, fibrous crystalline carbon, wherein the high value carbon generally remains attached to the pyrolysis catalyst after this step. Accordingly, in many embodiments, after the pyrolysis duration, the reactor is next switched to the carbon dislodging mode, wherein the dislodging agent/gas is used to dislodge the high value carbon from the pyrolysis catalysts, to be collected downstream of the reactor. In many embodiments, the pyrolysis duration is limited by the production rate of the high value carbon. In many such embodiments, it is critical to end the hydrocarbon pyrolysis process (by, for example, switching the reactor's supply gas to the dislodging agent to begin dislodging of the high value carbon) prior to the high value carbon clogging the reactor to the point it cannot be efficiently dislodged by the dislodging agent. As such, in many embodiments, the pyrolysis duration is less than 120 minutes. Furthermore, in many embodiments, the pyrolysis duration is dependent on the amount of the catalytic metal (e.g., Fe) used in the pyrolysis step. For example, FIG. 4 illustrates an “inflection point” (i.e., significantly diminished hydrocarbon conversion rate) in the course of CH₄ pyrolysis over Fe/θ-Al₂O₃ pyrolysis catalyst according to the methods of the instant application, which occurs after about 20 minutes for 5 wt. % Fe loading. Accordingly, in many embodiments, observing or otherwise detecting such an “inflection point” serves as a signal for switching the operating mode from pyrolysis to carbon dislodging. In some embodiments, the operating mode is switched shortly before the expected occurrence of the “inflection point.” For example, in some embodiments, the pyrolysis duration is approximately 12-20 min (depending on the amount of the catalytic metal, as illustrated in FIG. 4) for methane pyrolysis to produce H₂ and CNTs according to the instant methods. In some other embodiments, the pyrolysis duration is up to 2 hours.

In many embodiments, the pyrolysis temperature is chosen such as to ensure sufficient reaction rates (minimum operating temperature) and high H₂ yields, while avoiding sintering of the pyrolysis catalyst (maximum operating temperature). Accordingly, in many embodiments, the pyrolysis temperature is a temperature between 500° C. (932° F.) and 1000° C. (1832° F.). In many such embodiments, the pyrolysis temperature is a temperature between 500° C. (932° F.) and 900° C. (1652° F.). In many embodiments, especially wherein the hydrocarbon is methane and the pyrolysis catalyst is Fe, the pyrolysis temperature is 850° C.

It should be noted that heating of the catalyst bed in preparation for the hydrocarbon pyrolysis is important due to the endothermic nature of the hydrocarbon pyrolysis process. Accordingly, in many embodiments, the heating rate for the catalyst bed is a function of the heat transfer from the heating source to the catalyst bed. In many embodiments, the heating is provided to the catalyst bed using one of the methods selected from the group consisting of, but not limited to: combustion of natural gas, electrical heating, and or induction heating.

In many embodiments, the hydrocarbon is a single or a mixture of hydrocarbons such that it is in a gas phase at temperatures above 500° C. In many embodiments, the hydrocarbon is a chemical selected from the group consisting of: an alkane CₙH₂ₙ₊₂, wherein n is 1 to 4; an alkene CₙH₂ₙ, wherein n is 2 to 4; an alkyne CₙH₂ₙ₋₂, wherein n is 2 to 4; and any of isomer and combination thereof. However, it should be noted here, that a number of considerations, such as, for example: cost, safety, high H to C ratio, and good reaction rate control at high concentrations (needed to achieve high H₂ yields), might further limit the scope of the hydrocarbons suitable for use with the instant methods. For example, in some embodiments, C₂H₂ represents a sub-optimal choice of the hydrocarbon for at least the following reasons: 1) high cost—C₂H₂ is expensive and difficult to transport safely and cheaply; 2) safety—C₂H₂ is extremely unstable and can explode/is flammable at all volume concentrations; 3) low H to C ratio; and 4) poor pyrolysis reaction rate control at high concentration—C₂H₂ pyrolysis rate is expected to be too fast at high concentrations (needed to maximize the production of hydrogen) to allow for reliable control, resulting in reaction instability. Moreover, in order to better control the growth of the high value carbon from the pyrolysis of C₂H₂, the pyrolysis reaction temperature might also have to be lowered, along with the concentration/mole fraction of the C₂H₂ feed, which, in turn, will result in further lowering of H₂ yields.

In many embodiments, the hydrocarbon is delivered to the reactor via a hydrocarbon gas feed characterized by a hydrocarbon flow rate. In some such embodiments, the hydrocarbon gas feed additionally comprises one or more promoters. In many embodiments, the promoter is a chemical selected from the group consisting of: hydrogen, steam, sulfur-containing compound, such as thiophene, carbon monoxide, another hydrocarbon, and any combination thereof. In some such embodiments, wherein the promoter is the another hydrocarbon, the another hydrocarbon is a chemical selected from the group consisting of: an alkane, CₙH₂ₙ₊₂, wherein n is 1 to 4; an alkene CₙH₂ₙ, wherein n is 2 to 4; an alkyne CₙH₂ₙ₋₂, wherein n is 2 to 4; and any of isomer thereof, and any combination thereof. Accordingly, in many embodiments, the hydrocarbon gas feed comprises the hydrocarbon in the amount ranging from 20% to 100% by volume. In many embodiments, the hydrocarbon gas feed comprises the hydrocarbon in the amount ranging from 50% to 100% by volume. In many embodiments, the hydrocarbon gas feed comprises, in addition to the hydrocarbon, one or more promoters in the amount ranging from 0% to 10% by volume. In many embodiments, the hydrocarbon gas feed comprises, in addition to the hydrocarbon, one or more promoters in the amount ranging from 0% to 2% by volume.

In many embodiments, the hydrocarbon flow rate reaches a gas hourly space velocity between 100 h⁻¹ and 10,000 h⁻¹ at standard temperature (0° C.) and pressure (1 atm) (STP) conditions. In many embodiments, the hydrocarbon flow rate reaches a gas hourly space velocity between 1,000 h⁻¹ and 10,000 h¹. Here, the gas hourly space velocity is calculated by dividing the gas flow rate at STP conditions by the volume of the catalyst bed.

Furthermore, in many embodiments, the carbon dislodging step comprises a purge with the dislodging agent (i.e., a single gas or a gas mixture) characterized by a high-flow rate, a dislodging temperature and a dislodging duration, wherein the purge serves two purposes: 1) weakening the bond between the pyrolysis catalyst and the high value carbon accumulated atop; and 2) dislodging and carrying the high value carbon away out of the reactor in the gas stream. In many embodiments, the high-flow rate is a superficial gas flow rate 3 to 100 times of the minimum fluidization flow rate/velocity of the catalyst particles of the instant methods. In some such embodiments, the high-flow rate is approximately 1,000 to 10,000 sccm (1-10 standard liters per minute, slm). In many embodiments, the dislodging duration is the time it takes to dislodge most to all of the high value carbon produced in the hydrocarbon pyrolysis step. In many embodiments, the dislodging duration is less than 10 minutes. In many embodiments, after the dislodging duration, the reactor is switched to the catalyst reductive regeneration and pyrolysis. In many embodiments, the dislodging duration is limited by the rate of removal of the high value carbon from the pyrolysis catalyst. As such, in many embodiments, after most or all of the high value carbon has been removed from the pyrolysis catalyst as determined by an operator, the dislodging duration is over, and the reactor is switched back to the hydrocarbon pyrolysis mode after the reductive regeneration of the pyrolysis catalysts.

In many embodiments, the dislodging temperature is chosen such as to ensure sufficient reaction rates (minimum operating temperature), while avoiding sintering of the pyrolysis catalyst (maximum operating temperature). Accordingly, in many embodiments, the dislodging temperature is a temperature between 400° C. (752° F.) and 1000° C. (1832° F.). In many such embodiments, the dislodging temperature is a temperature between 500° C. (932° F.) and 900° C. (1652° F.). In some embodiments, especially wherein the dislodging agent comprises steam, the dislodging temperature is also chosen such as to minimize formation of CO₂. For example, in carbon oxidation by steam, CO formation is more thermodynamically favorable than CO₂ formation at temperatures above 700° C., while CO₂ formation is favorable at temperatures less than 700° C. Accordingly, in many embodiments, the dislodging temperature is higher than 700° C. In many embodiments, especially wherein the dislodging agent comprises steam, the dislodging temperature is 850° C. In many embodiments, the pyrolysis temperature and the dislodging temperature are the same temperatures or the same temperature ranges, however, in some embodiments these temperatures are different.

In many embodiments, the dislodging agent comprises an inert gas. In many such embodiments, the inert gas is a gas selected from the group consisting of: argon, nitrogen, helium, and any combination thereof. In many embodiments, the dislodging agent is delivered to the reactor via a dislodging agent feed characterized by the high-flow rate. In some such embodiments, the dislodging agent feed additionally comprises one or more promoters, wherein the promoter acts to weaken the chemical bond between the high value carbon and the pyrolysis catalyst in preparation for carbon dislodging. In many embodiments, the promoter is a chemical selected from the group consisting of: hydrogen, steam, carbon monoxide, oxygen, and any combination thereof. Notably, the addition of a small amount of steam during CNT synthesis has been shown to greatly enhance CNT quality by oxidizing away the undesirable, more reactive sp³ amorphous carbon while leaving the less reactive sp² bonded CNTs intact (as discussed, for example, in: Hata, K. et al. Water-Assisted Highly Efficient Synthesis of Impurity-Free Single-Walled Carbon Nanotubes. Science 306, 1362-1364 (2004); Cabana, L. et al. The role of steam treatment on the structure, purity and length distribution of multi-walled carbon nanotubes. Carbon 93, 1059-1067 (2015); and Nasibulin, A. G. et al. An essential role of CO₂ and H₂O during single-walled CNT synthesis from carbon monoxide. Chem. Phys. Lett. 417, 179-184 (2006), the disclosures of which are incorporated herein by reference). In addition, steam treatment of CNTs has also been reported to facilitate the easy separation of the CNTs from the catalyst. However, caution should be taken to avoid having too much steam, i.e., water (H₂O), in the dislodging agent feed, such as to protect the high value carbon from damage by oxidation. Furthermore, it should be noted, that dislodging of the high value carbon with the dislodging agent comprising steam may also slightly oxidize the catalytic metal of the pyrolysis catalyst (e.g., Fe), and, therefore, the pyrolysis catalyst might require reductive regeneration (e.g., with a H₂ purge) following such dislodging procedure. Accordingly, in many embodiments, the dislodging agent feed comprises the inert gas in the amount ranging from 80% to 100% by volume. In many embodiments, the dislodging agent feed comprises the inert gas in the amount ranging from 95% to 100% by volume. In many embodiments, the dislodging agent feed comprises one or more promoters in the amount ranging from 0% to 20% by volume. In many embodiments, the dislodging agent feed comprises one or more promoters in the amount ranging from 0% to 5% by volume. However, in many embodiments wherein the promoter is steam, the promoter comprises 0 to 3.1% of the dislodging agent feed. In many embodiments, the optimal amount of the steam in the dislodging agent feed is determined as needed, based on various process parameters, such as, for example: the dislodging temperature, and the reaction rate/amount of CNTs formed in the preceding pyrolysis step that needs to be dislodged. In many embodiments, the dislodging high-flow rate reaches a gas velocity sufficient to carry the dislodged carbon with the gas stream out of the reactor. A person skilled in the art should be able to effectively adjust the dislodging purge and catalyst regeneration parameters described herein within the ranges discussed herein to achieve the formation of H₂ and the catalyst-bound high value carbon, followed by the dislodging of the high value carbon and the pyrolysis catalyst regeneration, and the subsequent collection of the high value carbon downstream from the reactor.

In some embodiments, switching between the hydrocarbon pyrolysis and the carbon dislodging steps is accomplished using a programmable logic controller (PLC) based on the duration of each step. However, in many other embodiments, switching between the hydrocarbon pyrolysis and the carbon dislodging steps is accomplished using a PLC based on effluent output concentrations, or other operating parameters. For example, in some such embodiments, one suitable operating parameter of the hydrocarbon pyrolysis step is the measured differential pressure across the catalyst bed, wherein excess pressure indicates clogging of the reactor by carbon formation in the catalyst bed. As another example, in some embodiments, one suitable operating parameter of the carbon dislodging step is the composition of the flow gas at the reactor's outlet, combined with differential pressure across the catalyst bed, wherein the condition of the outlet gas composition being nearly identical to the inlet gas composition is indicative of the high value carbon being fully removed from the pyrolysis catalyst.

In some embodiments, the systems and methods of the instant application comprise additional intermediate steps and processes, such as to prepare the pyrolysis catalyst and reactor for the hydrocarbon pyrolysis step and or the carbon dislodging steps. In some embodiments, such additional processes include, but are not limited to: inert gas purges, catalyst activation, catalyst redeposition, oxidation of the remaining carbon, catalyst treatments, heating and or cooling the reactor, and any combination thereof. However, it should be stressed here, that these additional processes are not meant to be performed after every cycle of the semi-continuous methods of the instant application, but, rather, they may be turned to on an as needed basis, as determined by a person skilled in the art, to, for example, enhance the yields of the desired products, or, as another example, enhance the production rates.

In many embodiments, the pyrolysis catalyst comprises a material or materials having an elemental composition specially selected and or designed to optimize the hydrocarbon pyrolysis of the instant methods for both: 1) the formation of high value carbon and H₂ at high yields; and 2) the efficient separation and dislodging of the produced high value carbon from the pyrolysis catalyst. In many such embodiments, the pyrolysis catalyst is optimized for the formation of fibrous carbon. In many such embodiments, the pyrolysis catalyst comprises a catalytic metal. In many embodiments, the catalytic metal is an element selected from the group consisting of: iron, copper, molybdenum, nickel, cobalt, and any combination thereof. In many embodiments, the pyrolysis catalyst is known to be catalytically active in affecting hydrocarbon pyrolysis, wherein the pyrolysis catalyst comprises less than 50% of the catalytic metal by weight. In many embodiments, the pyrolysis catalyst comprises less than 10% of the catalytic metal by weight.

In many embodiments, in addition to the catalytic metal, the pyrolysis catalyst also comprises a plurality of inert carrier particles that support the catalytic metal and allow for fluidization of the catalytic metal within the reactor during the pyrolysis reaction. In many embodiments, the carrier particles are characterized by a high surface area. In many embodiments, the carrier particles possess a surface area of between 20 to 300 m²/g, as measured using the Brunauer-Emmett-Teller (BET) method. In many embodiments, the carrier particles are Geldart class A, B, and D particles with diameters ranging from 30 μm to 2000 μm. In many embodiments, the carrier particles are class B particles. In many such embodiments, the carrier particles are high surface area particles selected from the group consisting of: alumina, silica, magnesium oxide, zirconia, and any combination thereof. In some embodiments, the pyrolysis catalyst is synthesized from the catalytic metal and the plurality of the carrier particles via, for example, a wet impregnation method utilizing a wet solvent selected from the group consisting of: water, ethanol, and hexane. However, in other embodiments, the pyrolysis catalyst is synthesized from the catalytic metal and the plurality of the inert carrier particles via a dry impregnation method utilizing a dry solvent selected from the group consisting of: water, ethanol, hexane. In yet some other embodiments, especially wherein a greater control over the size of the catalytic metal particles is desired, the pyrolysis catalyst is synthesized from the catalytic metal nanoparticles and the plurality of the inert carrier particles via a and colloidal nanoparticle synthesis method.

In many embodiments, the pyrolysis catalyst is first, prior to loading into the reactor, synthesized in a pre-catalyst form, such as, for example, having the catalytic metal in its oxide form. In many such embodiments, the pyrolysis catalyst needs to be further activated by, for example, reducing the catalytic metal to its metallic state immediately prior to the hydrocarbon pyrolysis reaction within the reactor. In many such embodiments, the reduction to the active catalytic species utilizes a reducing agent, such as, for example, a gas selected form the group consisting of: hydrogen, carbon monoxide, hydrocarbons, ammonia, and any combination thereof. In many embodiments, the pyrolysis catalyst needs to be similarly reductively regenerated with the reducing agent after each hydrocarbon pyrolysis step/reaction. Nevertheless, it is important to note here, that, in many embodiments, such reductive regenerations of the catalyst are generally conducted in situ (within the reactor), and do not require removal/extraction of the catalyst from the pyrolysis reactor for regeneration, followed by catalyst redeposition, after every pyrolysis/dislodging cycle.

In many embodiments, the catalytic metal is iron (Fe), the carrier particles are θ-Al₂O₃, and the pyrolysis catalyst is Fe/θ-Al₂O₃. Notably, Fe is a suitable catalyst for both hydrocarbon pyrolysis and CNT growth for many reasons, including: high activity, CNT base-growth mechanism, low cost, and availability of data on use of Fe supported Al₂O₃ catalysts for high quality CNT growth. In general, Al₂O₃-supported Fe is a catalyst known for promoting growth of high quality CNTs. In addition, Al₂O₃ particles possess good fluidization characteristics, which makes them suitable candidates for the carrier particles of the instant systems and methods utilizing a fluidized bed reactor.

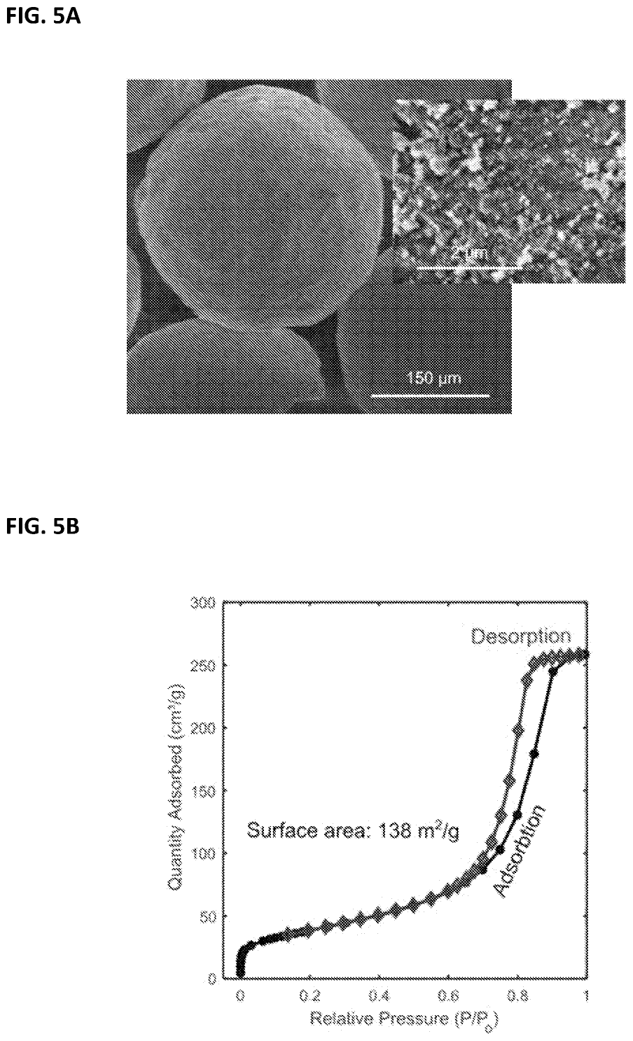

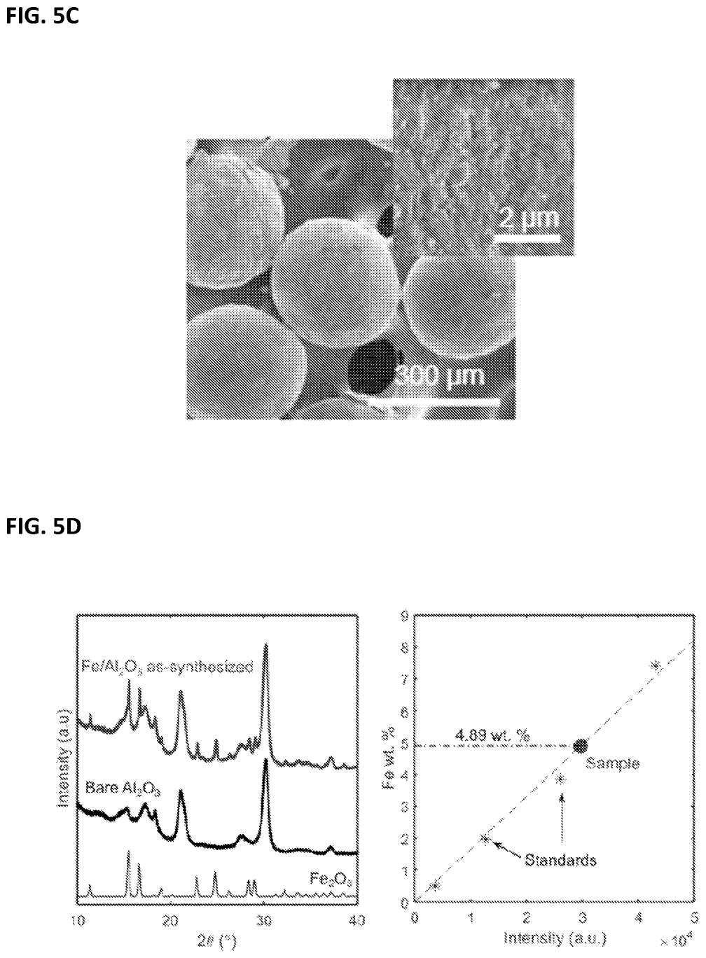

In addition, Fe/O-Al₂O₃ can be synthesized via an easily scalable incipient wetness impregnation process. For example, in some embodiments, the suitable Fe/θ-Al₂O₃ catalyst is prepared by loading Fe onto θ-Al₂O₃ carrier particles by incipient wetness impregnation with Fe(NO₃)₃·9H₂O in water; followed by catalyst calcination in air at 450° C. for 5 hours to afford the pre-catalyst Fe₂O₃/θ-Al₂O₃, which can, next, be loaded into the pyrolysis reactor and reduced to the active Fe form by exposure to H₂ within the pyrolysis reactor. FIGS. 5A through 5D illustrate such catalyst particle synthesis by providing a scanning electron microscopy (SEM) image and BET surface area analysis of θ-Al₂O₃ carrier particles (here, having 275 μm average diameter and 138 m² g⁻¹ specific surface area) pre-impregnation (FIGS. 5A and 5B, respectively), and a SEM image of the resulting as-synthesized Fe₂O₃/θ-Al₂O₃ pyrolysis pre-catalyst (FIG. 5C), wherein the Fe₂O₃ phase of the as-synthesized pyrolysis pre-catalyst was verified by x-ray diffraction and the catalytic metal weight loading was verified by x-ray fluorescence spectroscopy (XRF, FIG. 5D).

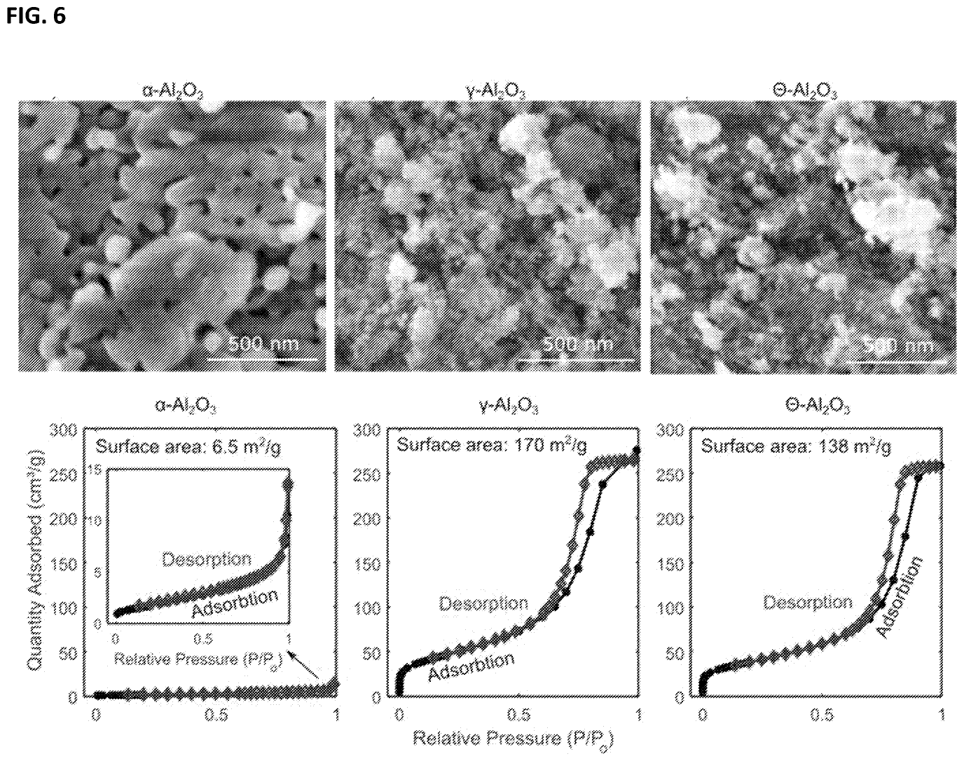

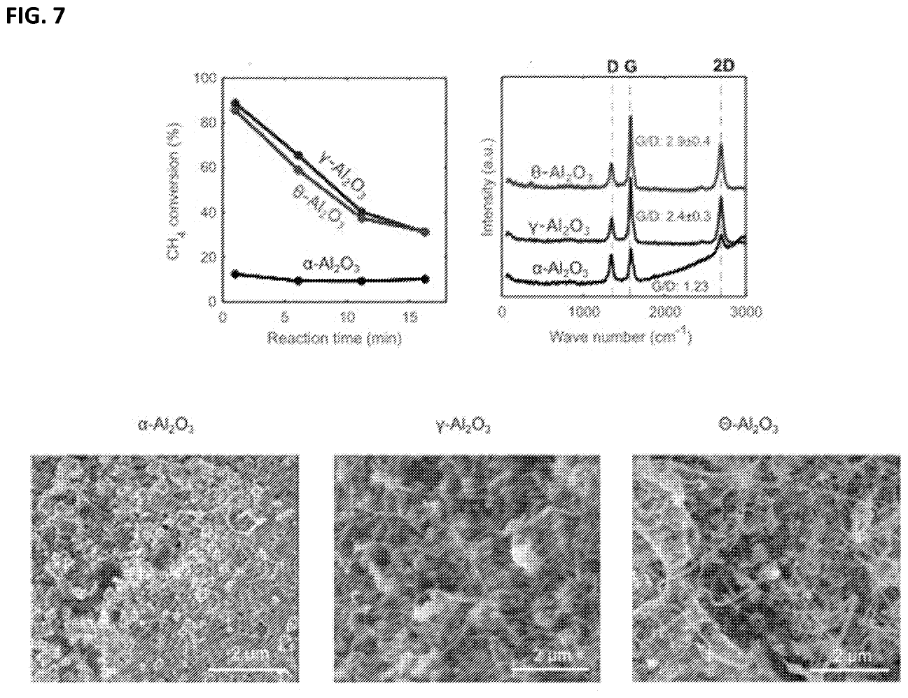

In many embodiments, a high surface area and high porosity support, such as that afforded by θ—Al₂O₃, serving as carrier particles (as illustrated by FIG. 6) efficiently promotes CNT growth via pyrolysis of hydrocarbons (e.g., CH₄) of the instant methods. Furthermore, the particle size of the catalytic metal (e.g., Fe) is also known to strongly affect CNT growth characteristics, wherein smaller particle sizes of the catalytic metal result in production of higher quality CNTs (see, for example: Nerushev, 0. A., et al. Particle size dependence and model for iron-catalyzed growth of carbon nanotubes by thermal chemical vapor deposition. J. Appl. Phys. 93, 4185-4190 (2003), the disclosure of which is incorporated herein by reference). As such, in many embodiments, high surface area catalyst support particles, such as, for example, Al₂O₃ carrier particles, aid in and promote thorough dispersion of the catalytic metal (e.g., Fe) onto and across the carrier/support particles, such the catalytic metal remains in a small particles state. To this end, FIG. 7 illustrates the effect that the high surface area of the Al₂O₃ support particles of many embodiments has on the CNT-producing performance of the CH₄ pyrolysis of the instant methods. According to the CH₄ conversion data (top left), Raman spectroscopy data (top right), and SEM images of the post pyrolysis Fe/Al₂O₃ beads (bottom row) provided in FIG. 7, CNT growth on Fe/α-Al₂O₃ is substantially worse than on either Fe/7-Al₂O₃ or Fe/θ-Al₂O₃. In addition, although not to be bound by any theory, the data presented in FIG. 7 indicates that the improved CNT growth over Fe/θ-Al₂O₃ is due to the high surface area of the θ-Al₂O₃ particles, rather than their 0 phase, since Fe loaded onto γ-Al₂O₃ support particles with similarly high surface area also produce similar amount of CNTs, while the low surface area α-Al₂O₃-supported Fe catalyst did not produce CNTs.

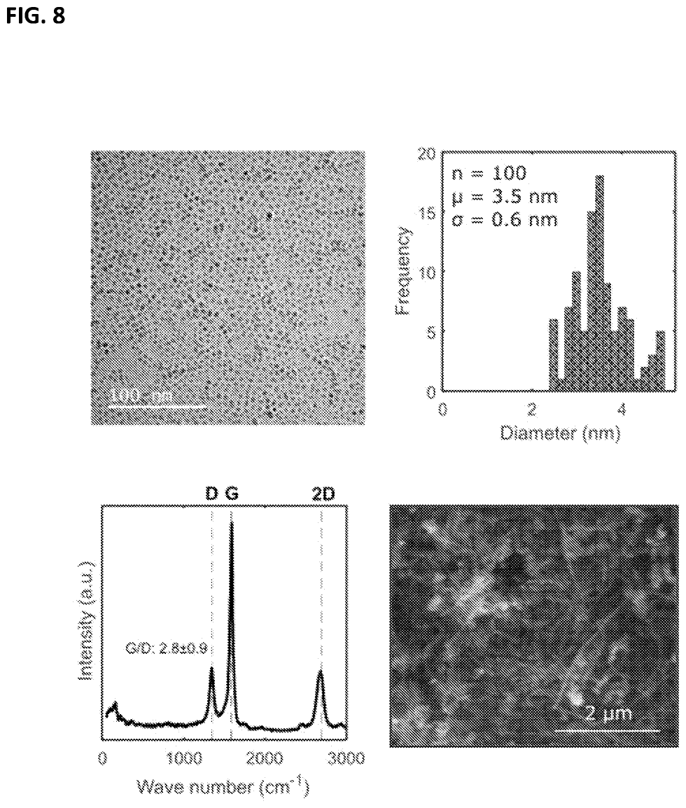

Furthermore, in some embodiments, Fe/θ-Al₂O₃ catalyst is prepared from pre-formed Fe nanoparticles to achieve better catalyst particle size and distribution control, and, in particular to obtain a catalyst comprising smaller Fe particles. In some such embodiments, a smaller Fe particle size is expected to afford higher quality CNTs from pyrolysis of hydrocarbons (including CH₄), as discussed above. To this end, as an illustrative example, FeNP/θ-Al₂O₃ catalyst particles were synthesized in a fashion alternative to the incipient wetness impregnation methods described above, but wherein, instead, colloidal Fe nanoparticles (FeNPs) of 1-10 nm diameter were drop-cast deposited onto 275 μm θ-Al₂O₃ particles and thoroughly characterized. FIG. 8 (top row) illustrates and characterizes the FeNPs prior to drop-casting onto the 275 μm θ-Al₂O₃ particles. Furthermore, regarding the catalytic activity of the FeNP/θ-Al₂O₃ particles, the data provided in FIG. 8, wherein the bottom row images show Raman spectrum (left) and SEM image (right) obtained for the CNTs grown by CH₄ pyrolysis of some embodiments over the FeNP/θ-Al₂O₃ beads, indicates that the quality (measured by Raman G/D ratio) of the CNTs grown using the FeNP/θ-Al₂O₃ pyrolysis catalyst is higher than the quality of CNTs grown from the catalysts obtained via the wet impregnation methods. Nevertheless, although not to be bound by any theory, it is expected that, due to the high temperatures used in hydrocarbon pyrolysis, wherein such temperatures are typically above the Tamman temperature (the onset of sintering) for many metals (e.g., Tamman temperature for Fe is ˜600° C.), the nanoparticles of the catalytic metal (e.g., Fe) will sinter into larger particles over time (see, for example, Argyle, M. & Bartholomew, C. Heterogeneous Catalyst Deactivation and Regeneration: A Review. Catalysts 5, 145-269 (2015), the disclosure of which is incorporated herein by reference). In addition, it should be noted, that the colloidal synthesis methods, such as the one used for fabrication of FeNP/θ-Al₂O₃ nanoparticles and described herein, are difficult to scale up, and, as such, they are less desirable for industrial applications, than the incipient wetness impregnation method that can afford other types of Fe/θ-Al₂O₃ particles (as also described herein). Accordingly, in many embodiments, the hydrocarbon pyrolysis catalyst of the instant systems and methods is a fluidizable catalyst comprising small, well-controlled Fe particles, such that it is amenable to synthesis via an easily scalable method and produces high quality CNTs.

### EXEMPLARY EMBODIMENTS

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric. Standard abbreviations may be used, e.g., s or sec, second(s); min, minute(s); h or hr, hour(s); and the like.

### Example 1 Cycled CH Pyrolysis With Fe θ-Al₂O₃ And 2.5% H₂O/Ar CNT Dislodging

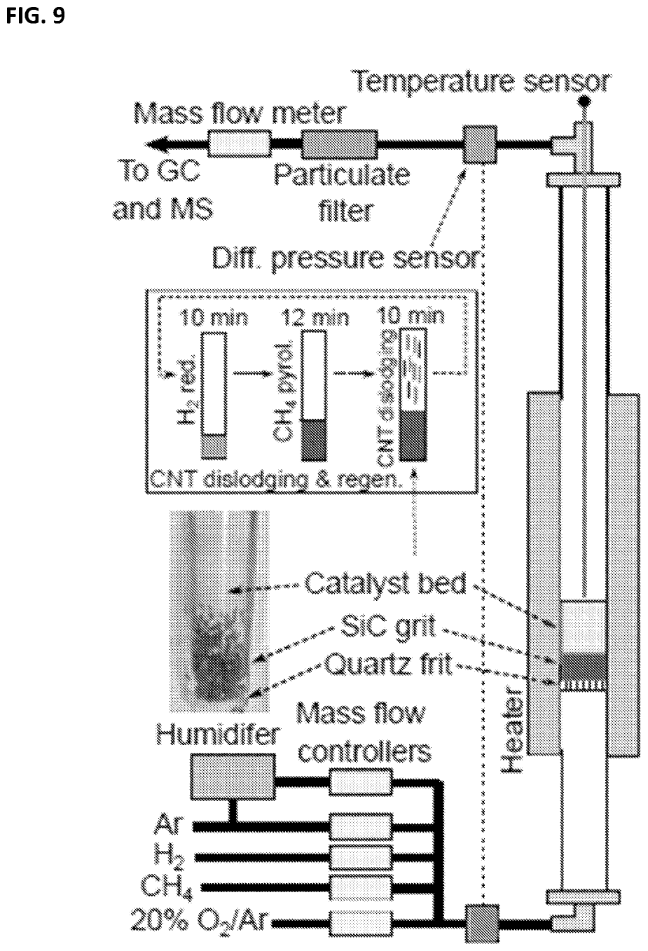

FIGS. 9 through 25 provide one example illustrating various aspects of the systems and methods of the instant application. More specifically, FIG. 9 illustrates a system used in a series of experiments conducted according to the methods of many embodiments, wherein 10 cycles of the semi-continuous CH₄ pyrolysis to produce CO₂-free H₂ and CNTs, followed by dislodging and removal of the resulting CNTs, were performed and thoroughly analyzed. In these experiments, CH₄ pyrolysis cycling was performed at 850° C., using 4.8 wt. % Fe/θ-Al₂O₃ catalysts (wherein wt. % refers to the weight proportion of the catalytic metal to the overall catalytic system) prepared according to many embodiments, in a quartz tube fluidized-bed reactor. Here, as in many embodiments, H₂ reduction of the Fe₂O₃/θ-Al₂O₃ pre-catalyst to active Fe/θ-Al₂O₃ pyrolysis catalyst was first performed in 500 standard cubic centimeters per minute (sccm) flow of pure H₂ for 10 minutes; after which initial step, each cycle consisted of the following three isothermal (850° C.) steps:
1) CH₄ pyrolysis in 350 sccm pure CH₄ flow (1,221 hr⁻¹ gas hourly space velocity);
2) CNT dislodging using vigorous fluidization in 3,080 sccm of 2.5% H₂O/Ar; and
3) reductive regeneration purge of the pyrolysis catalyst with 500 sccm of H₂.
   It should be noted here, that, according to many embodiments, the H₂ and CH₄ flow rates of these experiments were approximately 2.5 times higher than the experimentally determined minimum fluidization flow rates for the system used. In general, in many embodiments, the fluidization regime is correlated with the size and density of the catalyst/carrier particles. Furthermore, also notably, all the instances of the reductive regeneration of the pyrolysis catalyst were conducted in situ within the reactor, without removal of the catalyst for regeneration and redeposition, according to many embodiments of the instant application.

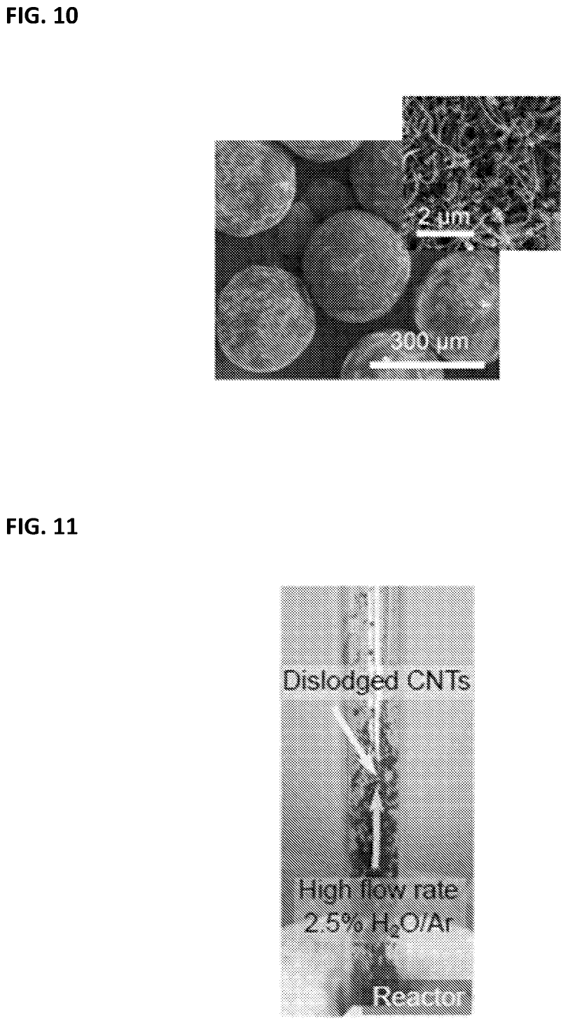

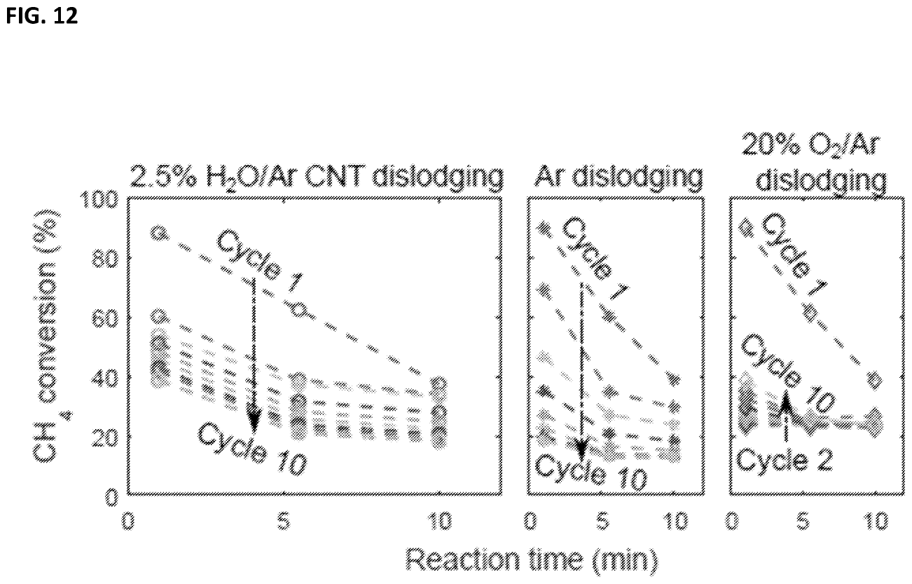

As such, FIGS. 5C and 10 show SEM images of the pyrolysis catalyst particles (here, Fe/θ-Al₂O₃) before any experiments and immediately after the CH₄ pyrolysis step of the first cycle, respectively. More specifically, FIG. 10 confirms production of densely distributed CNTs, according to the methods of many embodiments. Next, thus obtained CNTs were dislodged with 2.5% H₂O/Ar dislodging agent according to many embodiments. To this end, the gas flow rate of the CNT dislodging step of many embodiments was high enough (3,080 sccm in this case), that the dislodged CNTs were carried out of the reactor and could be visually observed leaving the reactor, as shown, for example, in FIG. 11. Finally, after the completion of the cycling (all 10 cycles), 200 sccm of argon was flowed through the reactor, while the reactor cooled, to prevent oxidation of the carbon.

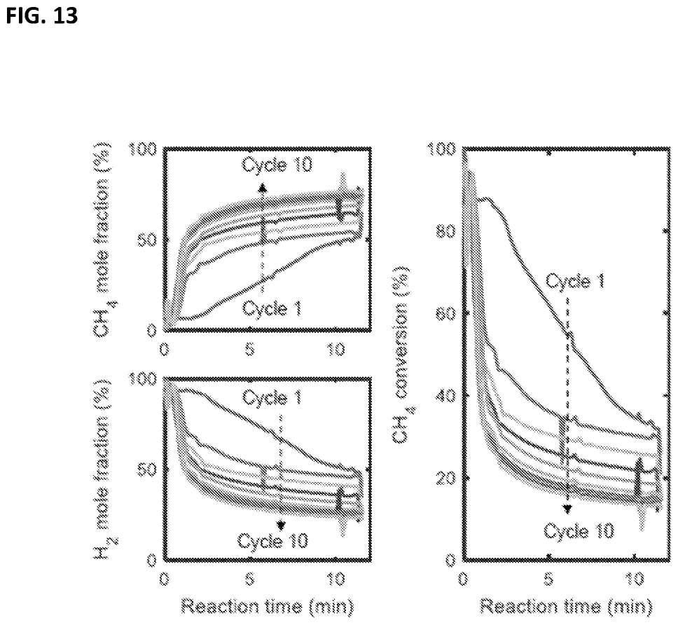

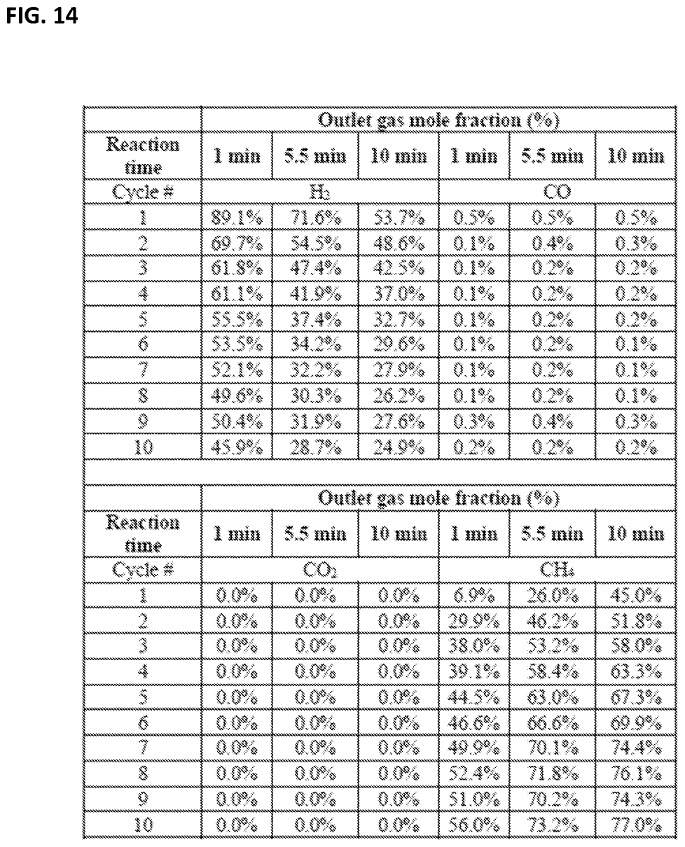

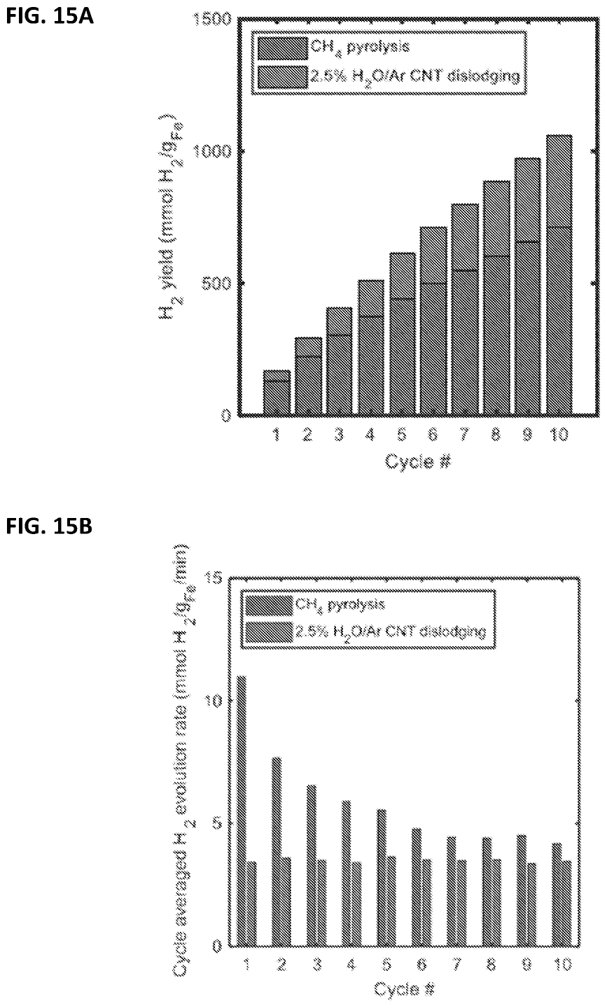

Next, FIGS. 12, 13, and the table in FIG. 14 provide CH₄ conversion data for each of the 10 cycles of the CH₄ pyrolysis experiments conducted according to many embodiments. More specifically, FIG. 12 shows gas chromatography (GC) data for CH₄ conversion during cycling wherein CNT dislodging was performed with 2.5% H₂O/Ar (left), as well as for control experiments, wherein CNT dislodging was performed with Ar (middle), and with 20% O₂/Ar (right); FIG. 13 shows CH₄ outlet gas mole fraction, H₂ outlet gas mole fraction, and CH₄ conversion changes for 10 cycles of the CH₄ pyrolysis with CNT dislodging by 2.5% H₂O/Ar, as measured using mass spectroscopy; while FIG. 14 tabulates the gas chromatography analysis results. Together, the collected data indicates that the initial (within the first minute) CH₄ conversion of the first cycle was approximately 90%, which was near the thermodynamic equilibrium conversion at 850° C. (as discussed, for example, in Guéret, C., et al. Methane pyrolysis: thermodynamics. Chem. Eng. Sci. 52, 815-827 (1997), the disclosure of which is incorporated herein by reference). However, after 10 minutes of the pyrolysis, the CH₄ conversion decreased to 40% by the end of the first cycle. Moreover, when 2.5% H₂O/Ar was used for CNT dislodging, the initial CH₄ conversion in each respective cycle decreased from 90% in cycle 1 to 40% in cycle 10. Notably, most of the decrease in CH₄ conversion occurred between cycles 1 and 5, wherein from cycle 5 onwards, the CH₄ conversion between the cycles was similar.

Furthermore, it should be noted, that CNT dislodging with H₂O/Ar produces additional H₂ (and CO) due to carbon gasification by H₂O via the reaction:

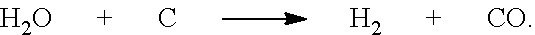

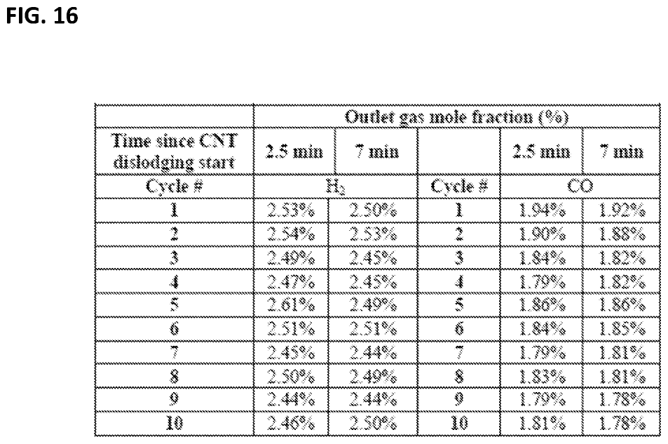

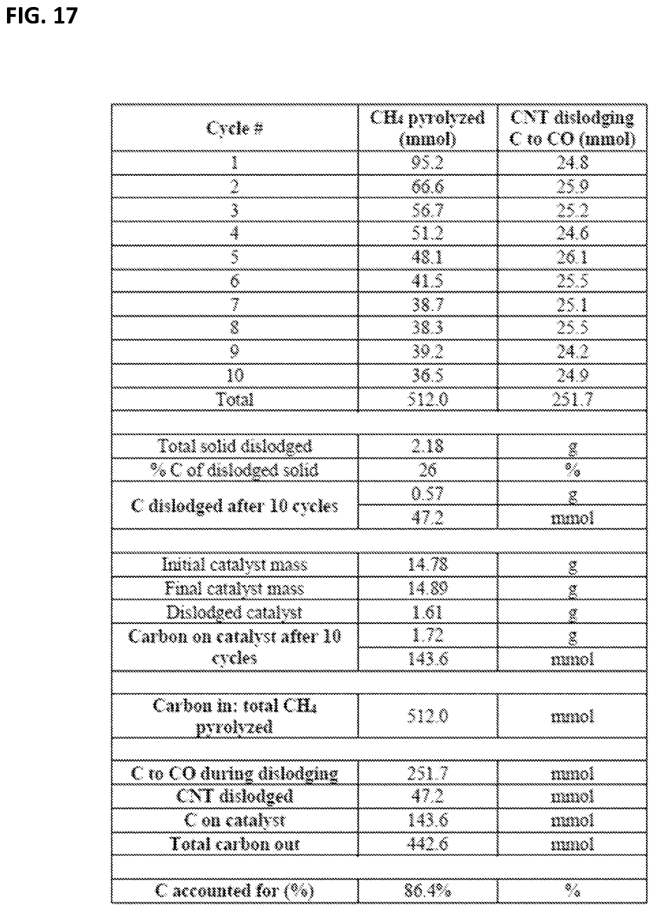

Accordingly, the data provided in FIG. 15A, which was obtained by time integration of the CH₄ conversion data, accounts for this additional H₂, by showing the cumulative H₂ yield from 10 cycles of the CH₄ pyrolysis and CNT dislodging by 2.5% H₂O/Ar in accordance with many embodiments. As seen from this figure, the cumulative H₂ yield from CH₄ pyrolysis was 704 mmol H₂/g_{Fe} after 10 cycles, while H₂O/Ar dislodging of CNTs afforded additional 350 mmol H₂/g_{Fe} after 10 cycles of the experiments. Therefore, in total, 1,059 mmol H₂/g_{Fe} was obtained from 10 cycles of the pyrolysis and CNT dislodging experiments conducted according to the instant methods (FIGS. 15A and 16). In addition, H₂ evolution rate during CH₄ pyrolysis varied from 12 mmol H₂/gFe/min in cycle 1 to 5 mmol H₂/gFe/min in cycle 10, while approximately 3.5 mmol H₂/gFe/min was produced during each CNT dislodging step (FIG. 15B). Notably, the observed H₂ selectivity during the CH₄ pyrolysis was >99.5% throughout; while <0.5% outlet mole fraction of CO was observed (FIG. 16). Furthermore, no higher hydrocarbons with concentrations above the detection limit were observed. Also notably, no CO₂ production was observed in either the CH₄ pyrolysis or the CNT dislodging steps, likely because, although not to be bound by any theory, CO formation is more thermodynamically favorable than CO₂ formation at 850° C. reaction temperature.

In addition, experiments with CNT dislodging by 1) pure Ar and 2) 20% O₂/Ar were also conducted for comparison with 2.5% H₂O/Ar dislodging conditions of many embodiments. To this end, FIG. 12 illustrates that using neat/dry Ar gas for CNT dislodging (middle) is less effective at maintaining high CH₄ conversion than using wet Ar (left). More specifically, although the initial CH₄ conversion in cycle 2 remained high at 60%, only 20% initial CH₄ conversion was achieved in cycle 10, as seen from such experiments in FIG. 12 (middle), wherein 3 slm of pure Ar (without H₂O) was used to dislodge CNTs. In turn, oxidation of the produced carbon and catalyst by 3 slm of 20% O₂/Ar first caused the CH₄ conversion to decrease greatly between cycle 1 and cycle 2 (from 90% to 20%, respectively), yet, notably, the CH₄ conversion next increased between cycle 2 and cycle 10 from 20% to 40% (FIG. 12, right). Nevertheless, oxidation by 20% O₂/Ar results in the undesirable production of CO₂ and, also, in the combustion of the pyrolysis produced CNTs, which prevents CNT collection.

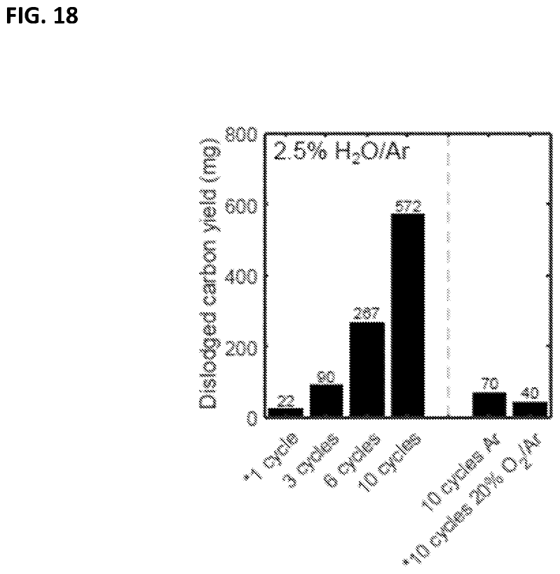

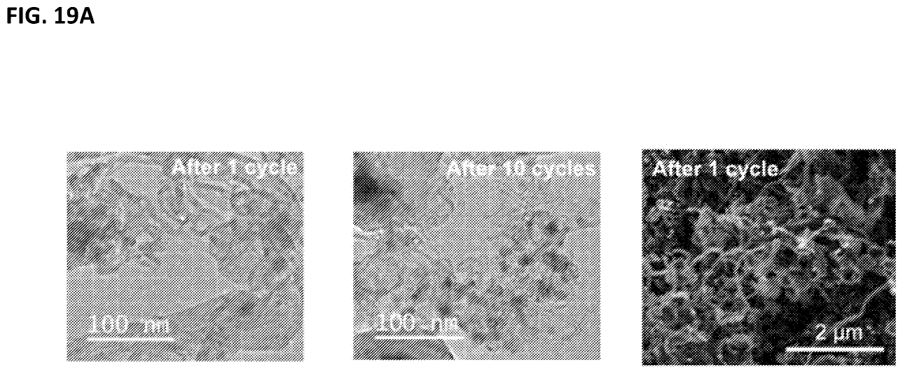

Next, the carbon dislodged during the high flow rate catalyst regeneration step was collected by a polytetrafluoroethylene (PTFE) filter with 2 μm pores and analyzed as illustrated by FIG. 17 through 20B. More specifically, solid products obtained from the CH₄ pyrolysis and carbon dislodging with 2.5% H₂O/Ar according to the methods of many embodiments were collected after 1 cycle, 3 cycles, 6 cycles, and 10 cycles for analysis. As such, first, according to the table provided in FIG. 17, approximately 86% of carbon was accounted for in the carbon balance across 10 cycles. Furthermore, as seen from FIG. 18, the yield of dislodged CNTs steadily increased from 90 mg after 3 cycles to 572 mg after 10 cycles. On the other hand, in the control experiments with pure Ar and with 20% O₂/Ar dislodging agents, carbon dislodging produced minimal amounts of dislodged CNT (FIG. 18).

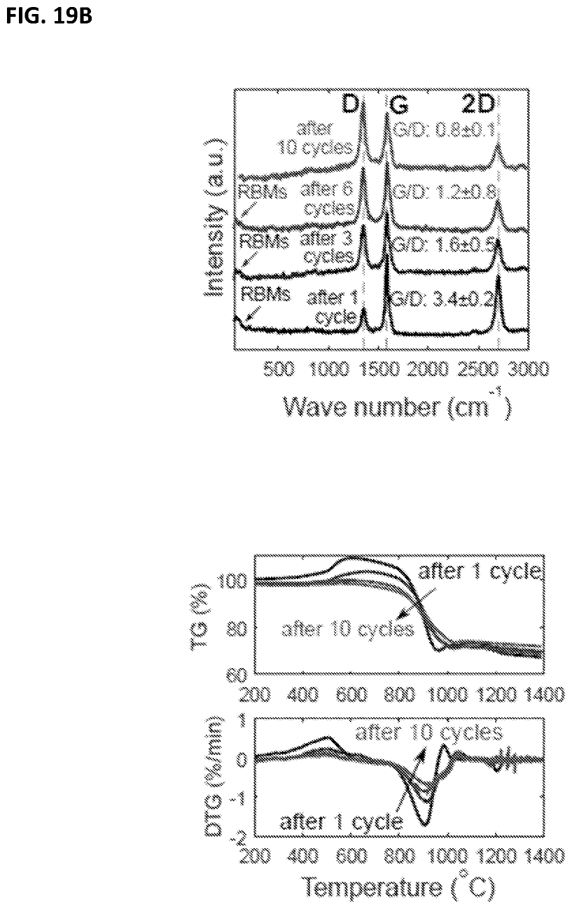

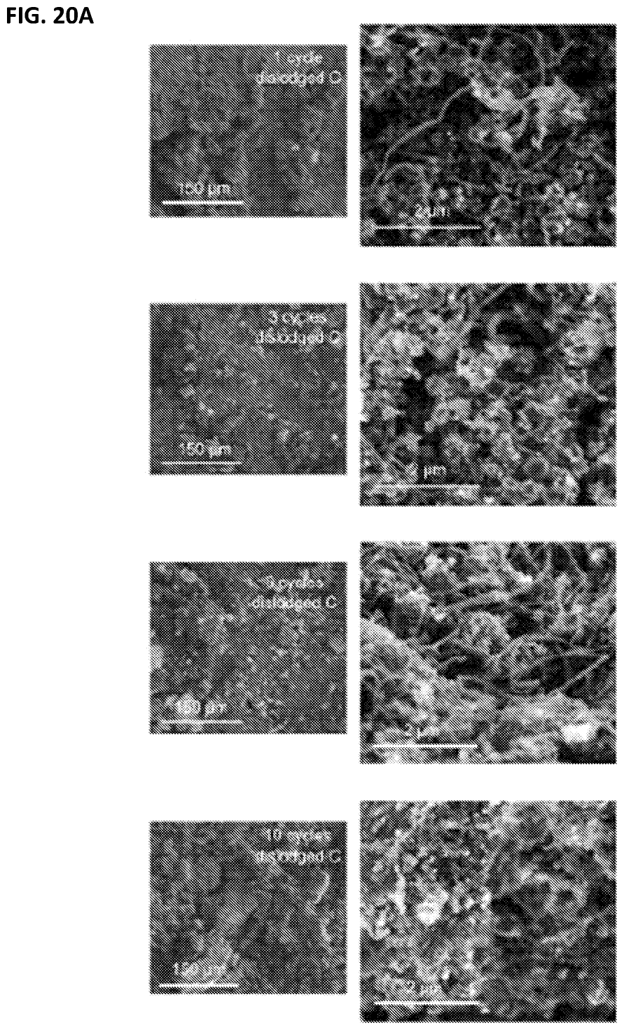

Moreover, FIG. 19A (leftmost and rightmost images) and 19B (top) illustrate that CNTs were produced and subsequently dislodged in cycle 1 of the experiments, as evidenced by the transmission electron microscopy (TEM) imaging (FIG. 19A, left), scanning electron microscopy (SEM) imaging (FIG. 19A, right), and Raman spectroscopy (RBMs, FIG. 19B, top), showing a 3.4 G/D peak intensity ratio and the presence of radial breathing modes at low wave numbers (although the signal intensity here is not sufficient to quantify the number of walls or tube diameter). Furthermore, as evidenced by the Raman spectroscopy data provided in FIG. 19B (top), wherein the G/D ratio decreased to 0.8 by cycle 10 and radial breathing modes were no longer observed, the quality of the dislodged CNTs decreased with increased cycling. Moreover, the TEM and SEM imaging presented in FIGS. 19A, 20A, and 20B, wherein the images show that the dislodged CNTs feature larger diameter fibers, less tubular structures, and more encapsulating carbon structures with increased cycling, also support this observation. In addition, FIG. 19B (middle and bottom) indicates that the dislodged carbon was mostly crystalline for all dislodged carbon samples, as CO₂ oxidation in a thermogravimetric analyzer (TGA) produced a large mass loss peak at 900° C. (as discussed, for example, in: Mendonga, F. G., et al. Selective Oxidation of Amorphous Carbon by CO₂ to Produce Fe@C Nanoparticles from Bulky Fe/C Matrices. J. Braz. Chem. Soc. (2015) doi:10.5935/0103-5053.20150212; Zhao, M.-Q. et al. Graphene/Single-Walled Carbon Nanotube Hybrids: One-Step Catalytic Growth and Applications for High-Rate Li—S Batteries. ACS Nano 6, 10759-10769 (2012); and Mistry, K. S., et al. High-Yield Dispersions of Large-Diameter Semiconducting Single-Walled Carbon Nanotubes with Tunable Narrow Chirality Distributions. ACS Nano 7, 2231-2239 (2013), the disclosures of which are incorporated herein by reference). However, the same analysis also points to non-CNT carbon (possibly, although not to be bound by any theory, amorphous) and other graphitic structures in the collected samples, as evidenced by the shoulders in the TGA curves in the 600° C. and 1000° C. regions, respectively.

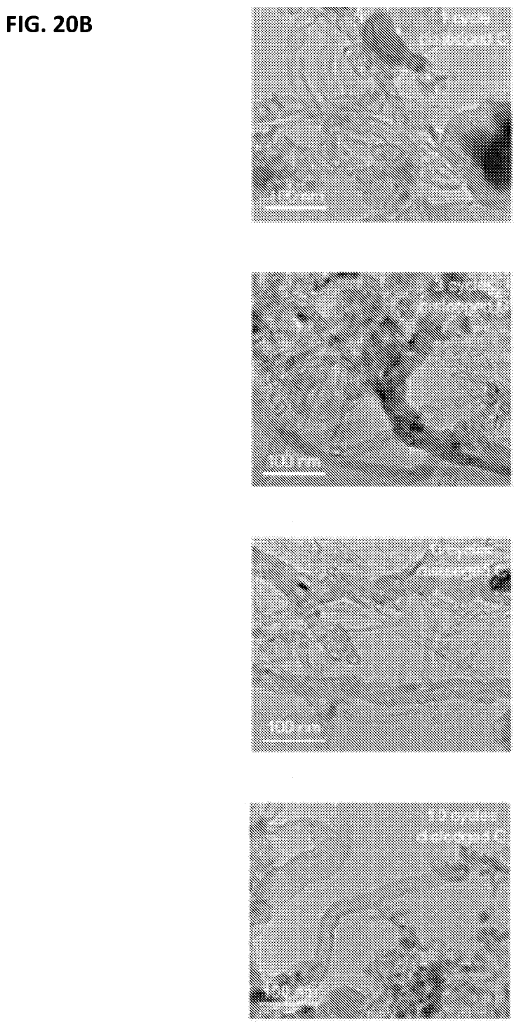

Next, FIG. 21 illustrates the changes in the state of the Fe/θ-Al₂O₃ pyrolysis catalyst throughout 10 cycles of the CH₄ pyrolysis, 2.5% H₂O/Ar purging, and H₂ catalyst regeneration cycling conducted according to the instant methods. According to the presented herein data, each successive cycle of steps comprising: the CH₄ pyrolysis, the CNT dislodging, and the hydrogen reduction of the catalyst, induces changes to the chemical and physical structure of the catalyst, and, as a result, the CH₄ conversion decreases and the produced carbon declines in quality as cycling progresses. More specifically, to illustrate this trend, FIG. 21 provides SEM images of the catalyst particles in cycles 1, 3, 6, and 10 (left to right columns, respectively), wherein each cycle comprises 3 steps of: hydrogen reduction, CH₄ pyrolysis, and CNT dislodging (top to bottom rows, respectively). As seen from the images in the left-most column, after H₂ reduction of cycle 1, the exposed Fe/θ-Al₂O₃ particles featured a rather smooth surface (top image). Next, after the CH₄ pyrolysis step of cycle 1, CNTs were seen to cover almost the entire surface of the imaged particle (middle image). Still next, after the step of CNT dislodging by high flow rate (here, 3,080 sccm) of 2.5% H₂O/Ar, much (although, notably, not all) of the particle surface was re-exposed, since the CNTs had been dislodged (bottom image).

Furthermore, as seen from the second from the left column of FIG. 21, by cycle 3 of the cycling methods of many embodiments, the Fe/θ-Al₂O₃ catalyst particles appeared smooth again after H₂ reduction, indicating that nearly all CNTs grown in cycles 1 and 2 had been dislodged or gasified by H₂O/Ar. Next, CNTs were again observed after the CH₄ pyrolysis step of cycle 3, however, notably, there were smaller quantities of CNTs as compared to cycle 1. Still next, the Fe/θ-Al₂O₃ catalyst particles appeared smooth and clean again after the CNT dislodging step of cycle 3. Overall, the same trend was observed after cycles 6 and 10, albeit with less CNTs grown after each successive CH₄ pyrolysis step.

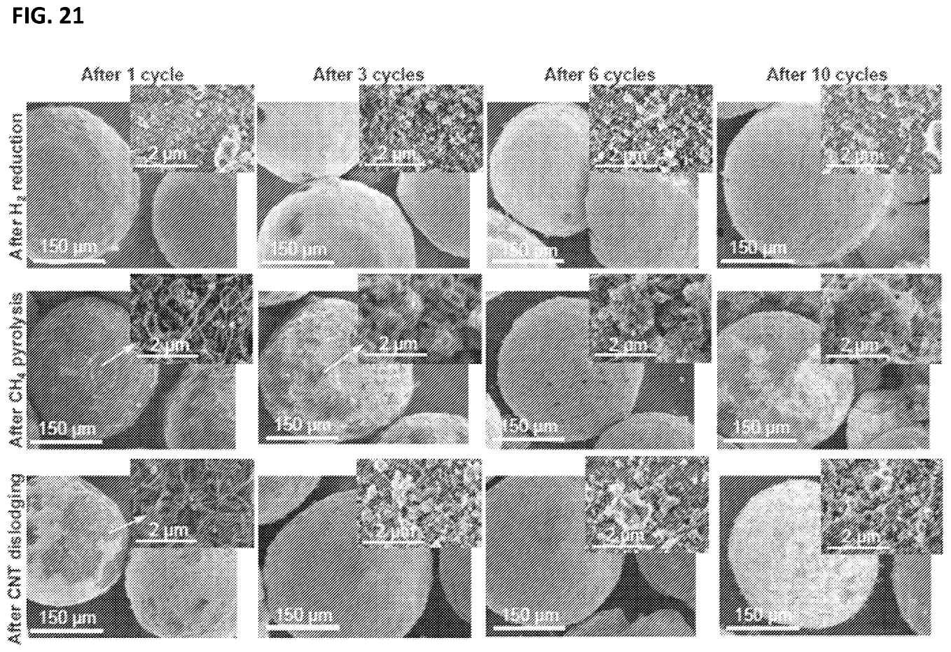

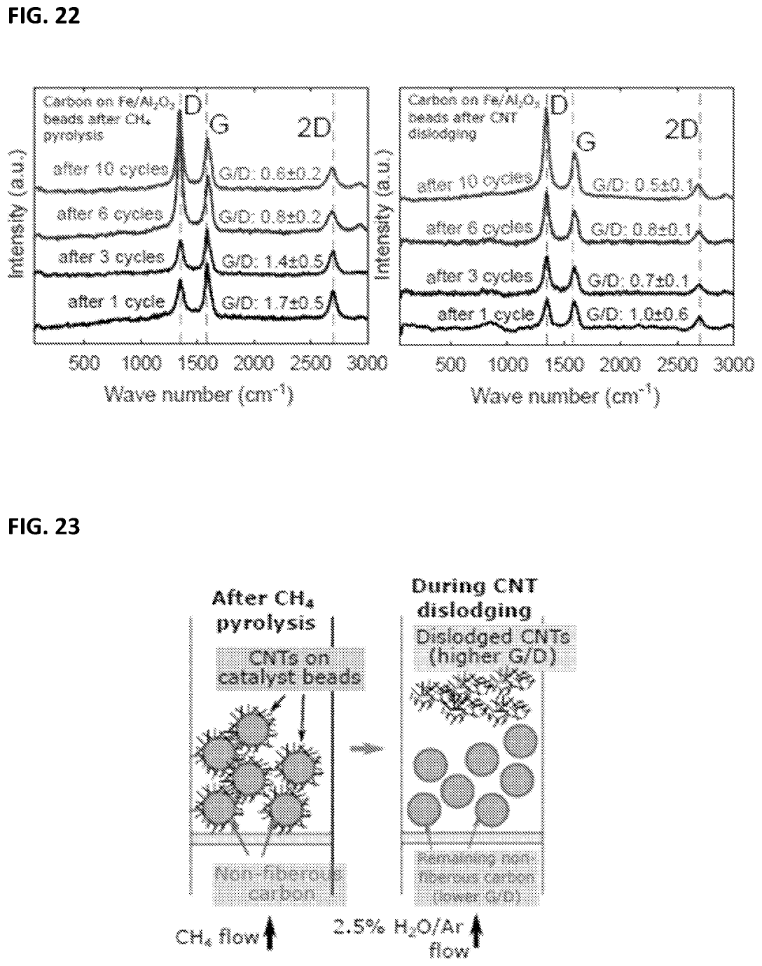

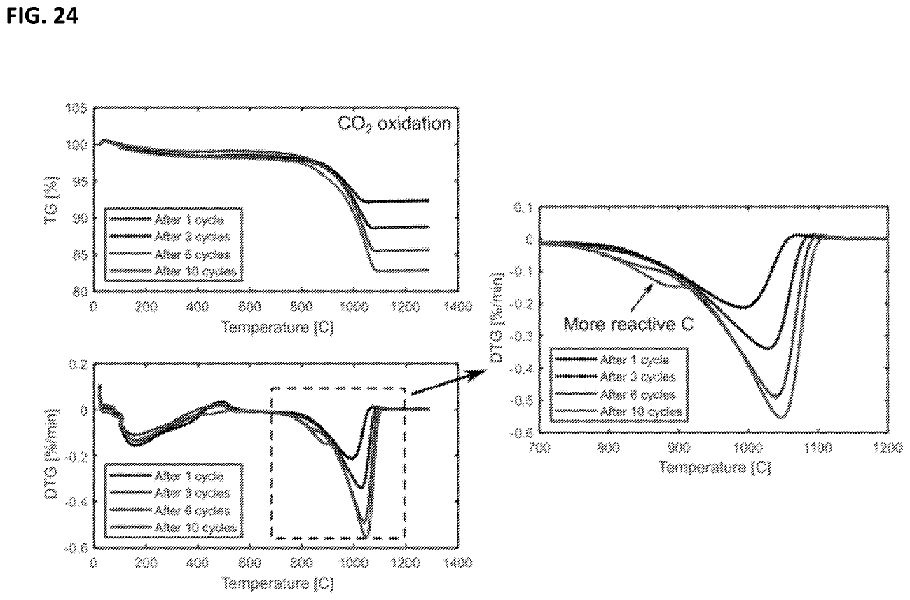

Moreover, FIG. 19B (top) and 22, together, provide data further characterizing the state of carbon and catalyst's Fe throughout the CH₄ pyrolysis cycling with 2.5% H₂O/Ar of the instant methods. More specifically, comparison of 1) the Raman spectra G/D ratio of the dislodged carbon provided in FIG. 19B (top); 2) the Raman spectra G/D ratio of the carbon seen on the Fe/θ-Al₂O₃ catalyst particles after the CH₄ pyrolysis step (FIG. 22, left); and 3) the Raman spectra G/D ratio of the carbon seen on the same Fe/θ-Al₂O₃ catalyst particles after the CNT dislodging step (FIG. 22, right), indicates that the quality of the dislodged carbon is higher than that of the carbon remaining on the particles after CNT dislodging. For example, the carbon on the catalyst particles after the CH₄ pyrolysis step of cycle 1 possessed a Raman G/D of 1.7 (FIG. 22, left), while the dislodged CNT from this cycle possessed a higher Raman G/D of 3.4 (FIG. 19B, top). Furthermore, the carbon remaining on the catalyst particles after the CNT dislodging step of cycle 1 possessed a lower Raman G/D of 1.0 (FIG. 22, right). In addition, a similar trend was observed for cycles 3, 6, and 10 of the experiments. Moreover, it was also observed that the Raman G/D on the Fe/θ-Al₂O₃ catalyst decreased with cycling (FIG. 22), which matches the trend observed for the dislodged carbon (FIG. 19B, top). As such, together, this data and observations indicate that, although not to be bound by any theory, the higher quality CNTs are more easily dislodged than non-tubular, lower quality CNTs, and or amorphous carbons as schematically depicted in FIG. 23. Notably, this hypothesis is also supported by the data obtained from TG and DTG analysis performed by CO₂ oxidation of the Fe/O-Al₂O₃ catalyst particles, thus analyzed after the CNT dislodging step of cycles 1, 3, 6, and 10 (as shown in FIG. 24). More specifically, as seen in plots of FIG. 24, the mass loss peak for a more reactive (possibly, although not to be bound by any theory, amorphous) carbon became noticeable with increased cycling.

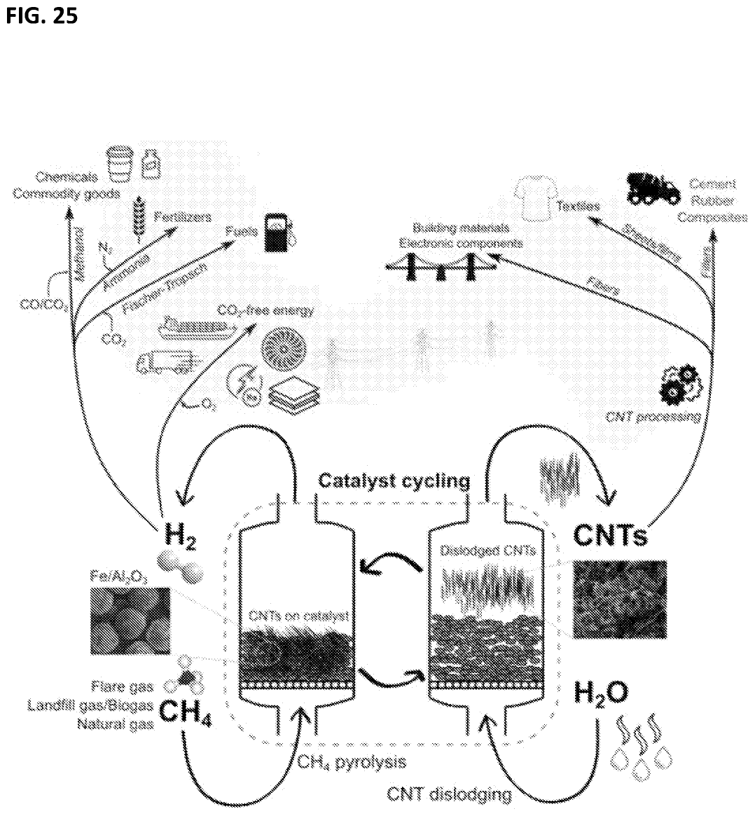

Accordingly, in many embodiments, the systems and methods described herein comprise a fluidized-bed reactor for a semi-continuous hydrocarbon pyrolysis process to produce H₂ and high value carbon, such as CNTs, wherein, in turn, the hydrocarbon pyrolysis process comprises multiple cycles of repeated pyrolysis and carbon dislodging purge steps. In many embodiments, the instant systems and methods afford high hydrocarbon conversion, high H₂ yield, and high yield of high value carbon. In many embodiments, the systems and methods are easily scalable. In many embodiments, the systems and methods produce the CO₂-free H₂ and high value carbon materials for applications and decarbonized solutions in areas as varied as energy, transportation, and industrial system, as illustrated, for example, in FIG. 25.

### Example 2—Preparation of Films Comprising CNTs

In many embodiments, the high value carbon, such as, for example, CNTs, produced according to the instant methods is readily incorporated into advantageous products. For example, films comprising high quality CNTs, such as those produced according to the instant methods, may replace oxide films in device applications, such as, for example, touch panels, LED/LCD displays, photovoltaics, lighting, and electrical components. As a more specific example, CNTs produced by and collected from the CH₄ pyrolysis conducted according to the instantly disclosed methods of many embodiments were used in a preparation of a CNT film. In particular, the CNT film was made via the following steps:
1) dispersing post-HCl washed CNTs in chlorosulfonic acid;
2) allowing the mixture to settle for 24 hrs (to allow the residual catalyst and undissolved material to sink to the bottom);
3) vacuum filtering the supernatant over an alumina filter and quenching it with chloroform;
4) submerging the resulting CNT thin film in water to lift it off; and
5) transferring the film to a clean glass slide and allowing it to dry.
   Next, the sheet resistance Rs and the optical transmittance T of the thus produced film comprising the CNTs afforded by instant methods were measured to be 1520 Ω/sq and 46%, respectively. In comparison, state-of-the-art CNT films made using highly crystalline, highly pure, few-walled CNTs can have a sheet resistance of ˜60 Ω/sq at 90% T (see, for example, Hecht, D. S. et al. High conductivity transparent carbon nanotube films deposited from superacid. Nanotechnology 22, 169501 (2011), the disclosure of which is incorporated herein by reference). However, it may be possible, although not to be bound by any theory, to improve the properties of the instant CNT films, by removing the Al₂O₃ impurities from the collected CNTs obtained via the instant methods, and or by optimizing the parameters of the hydrocarbon pyrolysis of the instant methods to improve their CNT selectivity (i.e., selectivity for CNT vs. non-CNT carbon) and carbon crystallinity. Nevertheless, in many embodiments, the systems and methods of the instant application afford high quality CNTs amenable to processing into films and or other advantageous products, such that they can be used as is, or further incorporated into valuable and essential commodities, such as illustrated, for example, in FIG. 25.

In general, as illustrated by FIG. 25, current applications for hydrogen gas include: ammonia production for incorporation into fertilizers and chemicals, a hydrogenation and desulfurization agent for refining crude oil products, a hydrogenation agent in the food industry, use as a fuel for aerospace applications, a feedstock for methanol and polymer production, a reducing agent for glass and semiconductor production, and a fuel in limited automotive and land-based transportation methods. Furthermore, the near future applications for hydrogen gas are expected to include: use as a reducing agent for atmospheric and point source carbon dioxide utilization, a transportable energy carrier, a fuel for power generation in both transportation and static applications, and a source of heat in commercial and residential spaces. In addition, current applications for carbon that could take advantage of access to large quantities of high value carbon include: material fillers used in tire production, rubber production, and composite material production. Furthermore, the expected future applications for carbon that could also take advantage of access to large quantities of high value carbon include: use as structural materials in buildings, bridges, roads, and houses, a filler material in cement and concrete, a lightweight structural material in material goods such as furniture, clothing, electronics, and sporting equipment, and electrical equipment such as in wires, switches, fuses, and electrical components. It should be noted here that carbon applications depend highly on the quality and cost of carbon to be utilized. Accordingly, in many embodiments, the CO₂-free H₂ and the high value carbon produced via implementation of the instantly described systems and methods are produced to scale and used in any of the application described above, or any other application, in a greenhouse-gas-free manner at low cost. More specifically, in many embodiments, the cost of H₂ production according to the instant methods is less than that of water electrolysis and steam-methane-reforming with carbon capture.

### Example 3 Catalyst Synthesis

Fe was impregnated onto θ-Al₂O₃ porous particles to synthesize the 4.8 wt. % Fe/0-Al₂O₃ catalyst. Here the weight percentage was elemental Fe mass divided by the total catalyst mass. First θ-Al₂O₃ particles (Sasol Puralox 300/130) were sieved to remove particle fragments with less than 250 μm diameter. Next, 14.1 g of the sieved θ-Al₂O₃ particles were used to prepare the catalyst for each fluidized bed reactor experiment. 8.0 mL deionized water and 5.1 g of Fe(NO₃)₃·9H₂O (iron(III) nitrate nonahydrate, 99+%, for analysis, Thermo Scientific) were mixed to result in about 12.5 mL of Fe solution. The solution was added to the 14.1 g sieved particles dropwise while mixing in a Vortex mixer. Afterwards, rotary evaporation was performed to dry the particles at 60° C. water bath temperature, rotation at 20 rpm, and 20 mbar pressure. Typically, 2-3 hours were required to completely dry the particles.

The calcination of the Fe/θ-Al₂O₃ particle catalyst was performed in a box furnace in static air. Dried particles loaded with catalyst were placed in a cylindrically shaped alumina crucible. The temperature profile used was as follows: temperature ramp from room temperature to 450° C. at 2° C. min⁻¹, isothermal treatment at 450° C. for 5 hours, and finally cooling at 2° C. min⁻¹ to room temperature. The resulting material was an orange/brown particle mixture with some loose catalyst powder. The loose catalyst powder was removed by sieving the resultant catalyst mixture using a 250 μm diameter sieve. The particles were then used for catalytic experiments.

### Example 4—CH₄ Pyrolysis Experiments

CH₄ pyrolysis experiments were performed in a vertical bench-scale fluidized bed reactor. The quartz reactor tube was a custom fabricated, 1 μm long, 20 mm inner diameter, 25 mm outer diameter, coarse quartz fritted 175 mm from the bottom tube made by Prism Research Glass. The quartz reactor tube was positioned inside a PID controlled, electrically heated, 440 mm long heating zone, single zone furnace manufactured by MTI Corp. The 15 g, 5 cm tall Al₂O₃ catalyst bed was supported by 23 g, 5 cm of 10 grit SiC which acted as a heat and gas distributor. The amount of SiC grit was chosen to ensure that minimal temperature gradients were present in the Al₂O₃ catalyst bed. The Al₂O₃ particles were provided by Sasol, and the SiC grit was obtained from Kramer Industries.

K-type, immersion probe, ungrounded thermocouples from OMEGA were placed at the top of the Al₂O₃ catalyst bed to measure its temperature throughout the pyrolysis reaction. To measure the pressure across the catalyst bed throughout the pyrolysis reaction, a high accuracy, 15 psi max (gauge pressure) pressure transducer from OMEGA was used. Aalborg differential pressure mass flow controllers purchased from Instrumart were used to introduce the desired gases (CH₄, H₂. Ar, O₂) into the reactor. Reaction gases (99.999% pure CH₄, 99.999% pure Ar, 99.9995% pure H₂, 99.99% pure 20% O₂/Ar) were purchased from Airgas USA. An Aalborg differential pressure mass flow meter also purchased from Instrumart was placed downstream of the fluidized bed reactor to measure the total flow rate of the product gas stream. To prevent carbon particulates produced during CH₄ pyrolysis from entering the gas stream and contaminating downstream instrumentation, 47 mm diameter, 2 μm pore size paper filters contained in a PTFE housing purchased from Savillex Corp. was placed immediately downstream of the reactor. All reactor components were connected by either ¼″ or ⅛″ stainless steel tubing purchased from Swagelok Company. Leak checking was performed by 1) spraying soap water on gas lines to watch for bubble formation, 2) ensuring the absence of the O₂ and N₂ peaks in the GC spectrum, and 3) ensuring the absence of O₂ (m/z 32) and N₂ (m/z 28) peaks in the mass spectrometer.

In a typical pyrolysis run, the Al₂O₃ catalyst bed was heated to 850° C. in 200 sccm flow of H₂ at 15.4° C. min¹ temperature ramp rate. Next, the sample was reduced with 200 sccm H₂ at 850° C. (isothermally) for 10 minutes. Then, the sample was pyrolyzed with 350 sccm CH₄ for 12 minutes at 850° C. Finally, CNT dislodging was performed with 3080 sccm H₂O/Ar flow for 10 minutes at 850° C. with H₂O provided by a CellKraft P-10 Humidifier. This cycle of isothermal H₂ reduction, CH₄ pyrolysis, and CNT dislodging was repeated as desired, and, notably, completely in situ, without any removal and redeposition of the pyrolysis catalyst. The sample was then cooled down to room temperature in Ar to prevent air oxidation of the formed carbon species. The flow rates chosen were approximately twice the minimum fluidization velocity of the catalyst bed for each respective gas. The mass and volume of the catalyst bed were measured before and after each experiment. After the experiment, the SiC grit and Al₂O₃ particles with attached carbon were separated using a 425 μm sieve from Gilson Company, Inc.

The product gases were analyzed by online multiple gas analyzer MG #5 gas chromatograph purchased from SRI instruments equipped with a thermal conductivity detector (TCD, used to quantify H₂ and CH₄) and a flame ionization detector with a methanizer (FID, used to quantify CH₄ and CO) using Ar as a carrier gas. Gas composition measurements were taken every 4.5 minutes starting at minute 2 after the introduction of CH₄ in each cycle. Since the CH₄ pyrolysis reaction products vary with time, the travel time for the gases to reach the GC from the reactor was important. The gas travel time was measured to be approximately 1 minute in the reactor setup using both a 1) mass flow meter, and 2) a mass-spectrometer placed just after the GC outlet. Therefore, it was determined that GC measurements were taken at 1—, 5.5-, and 10-minute reaction times after the introduction of CH₄. CH₄ conversions were calculated using the effluent stream flow rates as measured by the mass flow meter in conjunction with the gas composition measurements obtained from the gas chromatograph. The mass flow meter was calibrated to account for different mixture mole fractions of CH₄ and H₂. Some experiments were performed with an additional Hiden Analytical HPR-20 R&D mass spectrometer for gas composition analysis downstream of the GC. For mass-spec experiments, a 1-minute Ar purge was added between the H₂ and CH₄ pyrolysis step so that H₂ produced by CH₄ pyrolysis would not mix with H₂ in the previous step used for catalyst reduction.

### Example 5—Calculations of CH₄ Conversion; Gas Hourly Space Velocity; C, Fe, and Al₂O₃ wt. %; and Carbon Balance

CH₄ conversion was calculated by:

$${X}_{{CH}_{4}} = \frac{{\dot{m}}_{{CH}_{4 , in}} - {\dot{m}}_{{CH}_{4 , out}}}{{\dot{m}}_{{CH}_{4 , in}}} , \qquad ( 1 )$$

where X_{CH}_{₄} was the CH₄ conversion in % and \grave{m} was the mass flow rate in sccm. \grave{m}_{CH}_{_{4,in}} was typically set to 350 sccm. \grave{m}_{CH}_{_{4,out}} was determined by the total gas outlet flow rate \grave{m}ₜₒₜₐₗ as measured by the mass flow meter and the CH₄ outlet mole fraction Y_{CH}_{_{4,out}} in % as measured via gas chromatography. While the outlet gas composition was always changing and mass flow meter measurement required the gas composition to be set by the user, the outlet gas stream was predominantly H₂ and unreacted CH₄. Only trace amounts of CO and higher hydrocarbons were detected. Therefore, the mass flow meter was set to the CH₄ setting and a calibration curve of various H₂/CH₄ mixtures was constructed to determine the true total flow rate.

Gas hourly space velocity was calculated by:

$$G H S V = \frac{Q}{{V}_{cat}} , \qquad ( 2 )$$

where Q was the gas flow rate (350 sccm) and V_{cat} was the volume of the catalyst after slight physical agitation of the reactor to allow the catalyst particles to settle. The volume of the catalyst was determined using the measured height of the catalyst bed (5 cm) and the inner diameter of the quartz tube reactor (20 mm).

Thermogravimetric analysis (TGA) and x-ray fluorescence (XRF) were collectively used to determine the elemental composition (C, Fe, Al₂O₃ wt. %) of the bead and dislodged carbon samples. Prior to TGA oxidation, it was assumed that the sample was composed of carbon, Al₂O₃, and metallic Fe. Therefore, the initial sample mass m₁ was:

$${m}_{1} = {m}_{C} + {m}_{{Al}_{2} {O}_{3}} + {m}_{Fe} , \qquad ( 3 )$$

where m_{C}, m_{Al}_{₂}_{O}_{₃}, and m_{Fe} were the mass of carbon, alumina, and Fe, respectively. After TGA oxidation, it was assumed that all C was oxidized, Fe was oxidized to Fe₂O₃, and the Al₂O₃ was unaffected. Accordingly, the resulting sample mass m₂ was afforded by:

$${m}_{2} = {m}_{{Fe}_{2} {O}_{3}} + {m}_{{Al}_{2} {O}_{3}} , \qquad ( 4 )$$

where m_{Fe}_{₂}_{O}_{₃} was the mass of Fe₂O₃. Fe₂O₃ was likely the final sample state after 1400° C. oxidation, since the sample post-TGA oxidation appeared orange, which is the typical color of Fe₂O₃, as opposed to Fe₃ O₄, which appears black. The number of moles of Fe was unchanged during TGA oxidation, and so they were related by:

$${n}_{Fe} = 2 {n}_{{Fe}_{2} {O}_{3}} , \qquad ( 5 )$$

where n_{Fe} and n_{Fe}_{₂}_{O}_{₃} were the number of moles of Fe and Fe₂O₃, respectively. The number of moles could be related to the masses by:

$${n}_{Fe} = \frac{{m}_{Fe}}{{MW}_{Fe}} , \qquad ( 6 )$$

$${n}_{{Fe}_{2} {O}_{3}} = \frac{{m}_{{Fe}_{2} {O}_{3}}}{{MW}_{{Fe}_{2} {O}_{3}}} , \qquad ( 7 )$$

$$\frac{{m}_{Fe}}{{MW}_{Fe}} = 2 \frac{{m}_{{Fe}_{2} {O}_{3}}}{{MW}_{{Fe}_{2} {O}_{3}}} , \qquad ( 8 )$$

where MW_{Fe} and MW_{Fe}_{₂}_{O}_{₃} were the molar masses of Fe and Fe₂O₃. respectively. Since, m₁, m₂, and the molar masses of Fe and Fe₂O₃ were known, the list of unknown variables was: m_{C}, m_{Fe}, m_{Al}_{₂}_{O}_{₃}, and m_{Fe}_{₂}_{O}_{₃}. m_{Fe} was determined by XRF. Therefore, by forming a system of equations with equations 3, 4, and 8, it was possible to solve for m_{C}, m_{Al}_{₂}_{O}_{₃}, and m_{Fe}_{₂}_{O}_{₃}.

During CH₄ pyrolysis, CH₄ was converted into H₂ and solid carbon. Only trace amounts of CO and higher hydrocarbons were observed during the CH₄ pyrolysis conducted according to the instant methods and, thus, they were excluded from the carbon balance analysis presented herein. Next, the solid carbon afforded by the instant pyrolysis methods had several possible outflows: 1) it could leave the reactor as dislodged carbon, 2) it could be gasified by H₂O to CO (and H₂) during CNT dislodging by 2.5% H₂O/Ar, and 3) it could remain on the Fe/θ-Al₂O₃ catalyst particles (i.e., not be dislodged or reacted). Therefore, the carbon of the instant methods could be accounted for by the following equation:

$${n}_{{CH}_{4}} = {n}_{C , dis} + {n}_{C , cat} + {n}_{CO} , \qquad ( 9 )$$

where, n_{CH}_{₄}, n_{C,dis}, n_{C,cat}, and n_{CO} were the number of moles of converted CH₄, dislodged carbon, carbon remaining on the catalyst, and CO, respectively.

The number of moles of converted CH₄ was obtained from:

$${n}_{{CH}_{4}} = \frac{{ρ}_{{CH}_{4}}}{{MW}_{{CH}_{4}}} {\sum }_{i = 1}^{10} {\int }_{t = 0}^{t} {C}_{{CH}_{4}} ( t ) * {Q}_{{CH}_{4}} dt , \qquad ( 10 )$$

where ρ_{CH}_{₄} was the density of CH₄, MW_{CH}_{₄} was the atomic mass of CH₄, i was the cycle #, t was the pyrolysis reaction time, C_{CH}_{₄} was CH₄ conversion, and Q_{CH}_{₄} was the inlet volumetric CH₄ flow rate. The CH₄ conversion data obtained via mass spectroscopy was used for this analysis since mass spectroscopy possesses higher time resolution than gas chromatography. Similarly, the number of moles of produced CO was obtained from:

$${n}_{CO} = \frac{{ρ}_{CO}}{{MW}_{CO}} {\sum }_{i = 1}^{10} {\int }_{t = 0}^{t} {Y}_{CO} ( t ) * {Q}_{dis} dt , \qquad ( 11 )$$

where ρ_{CO} was the density of CO, MW_{CO} was the atomic mass of CO, i was the cycle #, t was the CNT dislodging reaction time, Y_{CO} was the mole fraction of CO, and Q_{dis} was the volumetric flow rate of the 2.5% H₂O/Ar CNT dislodging gas flow rate. The CO concentration was constant as a function of reaction time during CNT dislodging (FIG. 16).

The amount of the dislodged carbon n_{C,dis} was obtained from:

$${n}_{C , dis} = \frac{{m}_{dis} {X}_{C}}{{MW}_{C}} , \qquad ( 12 )$$

where m_{dis} was the total dislodged solid mass (including impurities), X_{C} was the mass fraction of carbon in the dislodged solid (calculated using the method discussed above), and MW_{C} was the molecular weight of carbon.

The amount of the carbon on the catalyst n_{C,cat} was obtained from:

$${n}_{C , cat} = \frac{{m}_{C , cat , final} + {m}_{C , cat , initial} - {m}_{cat , dislodged}}{{MW}_{C}} , \qquad ( 13 )$$

where m_{C,cat,final}, m_{C,cat,initial} and m_{cat,dislodged} were the catalyst mass after the reaction, catalyst mass prior to the reaction, and dislodged catalyst, respectively. The mass of the dislodged catalyst was obtained from:

$${m}_{cat , dislodged} = {m}_{dis} ( 1 - {X}_{C} ) . \qquad ( 14 )$$

The results of the carbon balance for 10 cycles of CH₄ pyrolysis with CNT dislodging by 2.5% H₂O/Ar are shown in FIG. 17.

### Example 6—Colloidal Nanoparticle Synthesis

Iron-Oleate Synthesis (precursor stock preparation). Mixtures were prepared at ambient lab temperature; ˜20° C. Iron (iii) chloride hexahydrate (14.62 mmol, Sigma Aldrich), ethanol and deionized (DI) water were divided into two 50 mL centrifuge tubes (Fisher) and vortexed to mix. Sodium oleate (97%, TCI) was placed in a 250 mL glass round bottom flask and dissolved in hexanes with 2 minutes of sonication. The iron chloride solution was transferred from the centrifuge tubes to the flask, and the flask was fitted with a vertical water condenser tube capped with a large rubber septum and vented with a 16 ga. needle. The flask containing the whole mixture was heated to 70° C. in an oil bath and held for 4 hours with rigorous stirring under lab atmosphere. The cooled mixture separated into two layers; a colorless aqueous layer below and a brownish-red upper organic layer containing the iron oleate complex. The mixture was transferred to a separatory funnel and the lower layer was extracted and discarded. The remaining organic layer was washed in the separatory funnel 3 times with DI H₂O. The wash mixture was left to rest for 30 minutes before the upper hexane layer was extracted via Pasteur pipet, while avoiding any of the minor aqueous layer.

The iron oleate complex/hexane mixture was then concentrated via a rotovap fitted with a water bath set to 40° C. The pressure was slowly decreased to prevent excessive boiling of hexanes; first to 500 mbar, then down to 335 mbar at a rate of approximately 1-5 mbar every 5 seconds over 3-5 minutes. The mixture was held at 335 mbar for 1.5 hours, then the pressure was decreased further to 300 mbar for another hour. The volume and mass of the evaporated solution were measured to confirm its density as being comparable to hexane. Solution was capped and stored overnight.

Thermolysis of Iron-Oleate Complex to form Iron Oxide Nanoparticles. The prepared Fe oleate complex was transferred via micropipette to a clean 50 mL three-neck round bottom flask with a magnetic stir bar. Oleic acid (90%, Sigma Aldrich), Oleyl alcohol (Alfa, tech grade, 80-85%), and 10 g diphenyl ether (Alfa) were then added to the flask via glass pipet. The left and right necks of the flask were sealed with rubber septa wrapped with PTFE tape. One of the septa was punctured with a needle to fit a thermocouple (also wrapped with PTFE tape) tightly through the bore at an angle to prevent obstruction of the stir bar. The flask was fitted with a heating mantle and the upper half of the flask was wrapped with Al foil. The mixture was heated to 250° C. at a rate of 10° C./min while under N₂ atm with vigorous stirring. The mixture was held at 250° C. for 30 min, and then cooled down rapidly by removing the heating mantle and blowing air on the flask while stirring continued. Once cooled to 100° C., the flask was placed in a water bath while still stirring, until the mix cooled to 30° C. The cooled solution was then split in half into two, transferring approximately 7.5 mL into each of two 50 mL centrifuge tubes. 27.5 mL acetone was added to each and both were vortexed and centrifuged at 8000 rpm for 30 minutes. The light red-brown supernatant was discarded, and the desired sediments were redispersed in 10 mL hexane and placed into glass scintillation vials and sealed with parafilm for storage. The resultant Fe nanoparticle solution in hexane was then added dropwise to the Al₂O₃ particles during vigorous mixing in the vortex machine.

### Doctrine of Equivalents

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A method for a semi-continuous hydrocarbon pyrolysis comprising:
providing a reactor, wherein the reactor is a fluidized-bed reactor comprising a catalyst bed;
providing a hydrocarbon at a hydrocarbon flow rate;
providing a pyrolysis catalyst, such that the pyrolysis catalyst facilitates a conversion of the hydrocarbon to hydrogen and a high value carbon, and loading the pyrolysis catalyst into the catalyst bed;
providing a dislodging agent at a dislodging flow rate;
providing a reducing agent at a reducing flow rate; wherein
the hydrocarbon flow rate, the dislodging flow rate, and the reducing flow rate are gas flow rates at least sufficient to fluidize the pyrolysis catalyst within the catalyst bed; and
repeating a plurality of cycles, each cycle at least comprising steps:
reacting the hydrocarbon to produce hydrogen and the high value carbon by flowing the hydrocarbon at the hydrocarbon flow rate over the pyrolysis catalyst within the reactor at a pyrolysis temperature for a pyrolysis duration; and collecting the hydrogen;
dislodging the high value carbon from the pyrolysis catalyst by flowing the dislodging agent at the dislodging flow rate over the pyrolysis catalyst within the reactor at a dislodging temperature for a dislodging duration; and collecting thus dislodged high value carbon and any additional hydrogen; and
regenerating the pyrolysis catalyst by flowing the reducing agent at the reducing flow rate over the pyrolysis catalyst within the reactor at a reducing temperature for a reducing duration;
to continuously generate and collect CO₂-free H₂ and the high value carbon over a course of the plurality of cycles in situ.

2. The method of claim 1, wherein providing the pyrolysis catalyst and loading the pyrolysis catalyst into the catalyst bed comprises first providing a pyrolysis pre-catalyst, wherein the pyrolysis pre-catalyst is inactive or less active than the pyrolysis catalyst; loading the pyrolysis pre-catalyst into the reactor, and activating the pyrolysis pre-catalyst by flowing the reducing agent at the reducing flow rate over the pyrolysis pre-catalyst within the reactor at the reducing temperature for the reducing duration to obtain the pyrolysis catalyst in the catalyst bed.

3. The method of claim 1, wherein the hydrocarbon is a gas selected from the group consisting of: an alkane CₙH₂ₙ₊₂, wherein n is 1 to 4; an alkene CₙH₂ₙ, wherein n is 2 to 4; an alkyne CₙH₂ₙ₋₂, wherein n is 2 to 4; and any of isomer and combination thereof.

4. The method of claim 3, wherein the hydrocarbon is methane.

5. The method of claim 1, wherein the hydrocarbon further comprises less than 10% by volume of a hydrocarbon promoter selected from the group consisting of: hydrogen, steam, a sulfur-containing compound, including thiophene, carbon monoxide, another hydrocarbon, and any combination thereof.

6. The method of claim 1, wherein the hydrocarbon flow rate is a gas hourly space velocity between 100 h⁻¹ and 10,000 h⁻¹ at the standard temperature of 0° C. and the standard pressure of 1 atm.

7. The method of claim 6, wherein the hydrocarbon flow rate is a gas hourly space velocity between 1,000 h⁻¹ and 10,000 h⁻¹ at the standard temperature of 0° C. and the standard pressure of 1 atm.

8. The method of claim 1, wherein the pyrolysis catalyst comprises a catalytic metal and a plurality of support particles.

9. The method of claim 8, wherein the pyrolysis catalyst comprises less than 50% of the catalytic metal by weight.

10. The method of claim 9, wherein the pyrolysis catalyst comprises less than 10% of the catalytic metal by weight.

11. The method of claim 8, wherein the catalytic metal is an element selected from the group consisting of: iron, copper, molybdenum, nickel, cobalt, and any combination thereof.

12. The method of claim 8, wherein the plurality of support particles possesses a surface area of between 20 to 300 m²/g, as measured using Brunauer-Emmett-Teller method.

13. The method of claim 8, wherein the plurality of support particles are Geldart class A, B, or D particles with diameters ranging from 30 μm to 2000 μm.

14. The method of claim 8, wherein the plurality of support particles are high surface area particles selected from the group consisting of: alumina, including θ-Al₂O₃ and γ-Al₂O₃, silica, magnesium oxide, zirconia, and any combination thereof.

15. The method of claim 1, wherein the pyrolysis catalyst is Fe/θ-Al₂O₃.

16. The method of claim 2, wherein the pyrolysis pre-catalyst is Fe₂O₃/θ-Al₂O₃ and the pyrolysis catalyst is Fe/θ-Al₂O₃.

17. The method of claim 1, wherein the pyrolysis catalyst is FeNP/θ-Al₂O₃.

18. The method of claim 1, wherein the conversion of the hydrocarbon is 20 to 100%.

19. The method of claim 18, wherein the conversion of the hydrocarbon is 40 to 100%.

20. The method of claim 19, wherein the conversion of the hydrocarbon is 60 to 100%.

21. The method of claim 1, wherein the high value carbon is fibrous and or fibrous crystalline carbon.

22. The method of claim 1, wherein the high value carbon is a valuable carbonaceous matter selected from the group consisting of: SWCNTs and DWCNTs, wherein the SWCNTs and the DWCNTs are in the range of 1-5 nm diameter; MWCNTs, wherein the MWCNTs are in the range of 2-50 nm diameter; and carbon fibers with tube diameters larger than 50 nm, but still possessing an aspect ratio of length to diameter of greater than 25; and any combination thereof.

23. The method of claim 1, wherein the dislodging agent comprises an inert gas and an optional dislodging promoter, and wherein the optional dislodging promoter comprises less than 20% by volume of the dislodging agent.

24. The method of claim 23, wherein the optional dislodging promoter comprises less than 5% by volume of the dislodging agent.

25. The method of claim 23, wherein the inert gas comprises a gas selected from the group consisting of: argon, nitrogen, helium, and any combination thereof.

26. The method of claim 23, wherein the optional dislodging promoter comprises a gas selected from the group consisting of: hydrogen, steam, carbon monoxide, oxygen, and any combination thereof.

27. The method of claim 1, wherein the dislodging agent comprises argon and steam, and wherein steam comprises less than 3.1% by volume of the dislodging agent.

28. The method of claim 27, wherein steam comprises 2.5% by volume of the dislodging agent.

29. The method of claim 1, wherein the dislodging flow rate is a superficial gas velocity 3 to 100 times of the minimum fluidization velocity of the pyrolysis catalyst.

30. The method of claim 1, wherein the reducing agent is a gas selected from the group consisting of: hydrogen, carbon monoxide, hydrocarbons, ammonia, and any combination thereof.

31. The method of claim 1, wherein the reducing agent is hydrogen gas.

32. The method of claim 1, wherein the pyrolysis temperature is between 500° C. and 1000° C.

33. The method of claim 32, wherein the pyrolysis temperature is between 500° C. and 900° C.

34. The method of claim 33, wherein the pyrolysis temperature is 850° C.

35. The method of claim 1, wherein the dislodging temperature is between 400° C. and 1000° C.

36. The method of claim 35, wherein the dislodging temperature is between 500° C. and 900° C.

37. The method of claim 1, wherein the dislodging temperature is above 700° C.

38. The method of claim 36, wherein the dislodging temperature is 850° C.

39. The method of claim 1, wherein the pyrolysis temperature, the dislodging temperature, and the reducing temperature are the same temperature.

40. The method of claim 1, wherein the hydrocarbon is methane, the pyrolysis catalyst is Fe/0-Al₂O₃, comprising 4.8% of Fe by weight, the dislodging agent is humidified argon comprising 2.5% by volume of steam, the reducing agent is H₂, and the pyrolysis, the dislodging, and the reducing temperatures are 850° C.
